(19) United States
(12) Patent Application Publication
(10) Pub. No.: US 2025/0067927 A1
(43) Pub. Date: Feb. 27, 2025

(54) OPTICAL PHASED ARRAY FIBER COUPLER

(71) Applicant: The Regents of the University of Michigan, Ann Arbor, MI (US)

(72) Inventors: Dachuan WU, Dearborn, MI (US); Yasha YI, Troy, MI (US)

(21) Appl. No.: 18/810,944

(22) Filed: Aug. 21, 2024

Related U.S. Application Data
(60) Provisional application No. 63/533,771, filed on Aug. 21, 2023.

(51) Int. Cl. G02B 6/12; G02B 6/13; G02B 6/293

(52) U.S. Cl. CPC G02B 6/12007; G02B 6/13; G02B 6/29301

(57) ABSTRACT

An optical phased array device, and method of fabricating an optical phased array device, where the optical phased array device has a plurality of self-aligned waveguides having an on-chip edge coupler at which a single mode optical fiber is coupled to each of the plurality of self-aligned waveguides; and/or has a fiber coupling interface and a plurality of waveguide layers sharing a common edge at the fiber coupling interface, wherein the fiber coupling interface is configured to couple a single mode optical fiber to each of the plurality of waveguide layers at the common edge. The method includes fabricating an optical phased array according to a layer thickness for one or more waveguide layers, wherein the layer thickness is determined based on mode matching data derived from a mode profile at an input coupling interface.

### GOVERNMENT FUNDING

This invention was made with government support under 1428069 awarded by the National Science Foundation. The government has certain rights in the invention.

### TECHNICAL FIELD

This invention relates to optical phased arrays and devices incorporating an optical phased array (OPA), such as those used for light detection and ranging (lidar), and, more particularly, to fiber couplers used to couple an optical fiber carrying light to an OPA, namely a three-dimensional (3D) end-firing or edge-firing OPA.

### BACKGROUND

During the development of the electronic integrated circuit (IC) industry, photonic integrated circuits (PIC) have been proposed as the next-generation chips and studied for decades. Normal PICs inherit the mature CMOS fabrication process from electronic IC, and such PICs usually have a single waveguide layer on the top of a silicon-on-insulator (SOI) platform or are based on deposited silicon nitride (Si₃N₄). Usually, the fabrication uses the top layer as the waveguide layer, and then the electronic contacts are fabricated above the waveguides for the modulation. While this technique takes some advantages from the mature CMOS fabrication process, it restricts the PICs in the single-waveguide-layer configuration, limiting the device performance. In recent years, the electronic IC industries have shown a trend of converting memory and computing unit designs from 2D to 3D. Nevertheless, these fabrication processes can also be applied to 3D multi-waveguide-layer PICs. A relatively new type of PIC, called optical phased array (OPA), has drawn much research attention due to its potential in lidar applications. Yet, this device suffers from the limitation of single-waveguide-layer configuration.

OPAs are used in various devices to guide light (including, for example, infrared and/or near-infrared electromagnetic radiation), such as for use in lidar applications, and may be coupled to a light source and/or a light sensor so that waveguides, using their waveguide paths within the optical phased array, guide light appropriately between a collector side (at which the light source/light sensor are located) to an emitter side (at which emitters (emitting or firing portions) are located). At the emitter side, light passes between the optical phased array and the atmosphere. It will be appreciated that the term “light” is used herein in the context of optical phased arrays and that non-visible light may be transmitted and/or received by the OPA device—for example, in the context of lidar, a broader spectrum than just visible light is commonly used, such as electromagnetic radiation having infrared and ultraviolet wavelengths.

An edge-firing emitter is fabricated through generating a pattern layer and a cladding layer (collectively, the pattern layer and cladding layer are referred to as a waveguide-cladding layer) on a base substrate. An edge-firing OPA capable of steering and/or sensing light in three dimensions (referred to as a three-dimensional (3D) OPA) may be manufactured by stacking multiple waveguide layers on top of one another.

Lidar systems are used primarily for full dimensional sensing, with applications ranging from navigation for autonomous vehicles to robotics, imaging, unmanned aerial vehicles (UAVs), national security, healthcare, and the Internet of Things (IOTs). With the time of flight (ToF) or frequency modulated continuous wave (FMCW) mechanism, a lidar system can generate a 3D map of its surroundings with distance and velocity information. Compared to the common mechanical lidar, which is usually a high cost and slow in scanning, a chip-scale lidar system can provide both increased range and resolution required for high-speed driving—and other tasks, such as real-time facial recognition—that are beyond the capability of current lidar systems. With the growing interest from the research community in chip-scale lidar, beam steering based on the integrated OPA has drawn a lot of research effort in the past decade.

Significant progress has been achieved, including thermal tuning, electro-optics tuning, high sensitivity wavelength tuning, integrated on-chip light source, and side lobe suppression by aperiodic or apodized array placement. However, most on-chip OPA research stays in the single-waveguide-layer structure. The OPA formed by a single layer can only emit the beam by diffractive components such as grating couplers, which has narrowband and relatively low emitting efficiency. In previous work, it was shown that about half of the light could be emitted to the substrate in a normal grating-coupler-based OPA. The optical efficiency of the beam steering devices is directly related to the detection range of lidar, and most applications (particularly for AD and ADAS) require a detection range to be at least 100 meters. Designs can be applied to suppress substrate leakage of the energy, but only benefits in a narrow bandwidth.

Previous works have attempted to address the relatively low emitting-efficiency challenge. The basic idea is to use end-fire emitters to achieve high efficiency. Further works aiming to confine the waveguide spacing to half-wavelength have been done using various approaches. These works employ the configuration with a single waveguide layer and, thus, offer the convenience of tuning the phase of each waveguide. Unfortunately, the beam emitted by such a configuration is a fan-beam with only 1D convergence, as the single waveguide layer can only form a 1D converged beam for the OPA on the edge of the chip. The possibility of emitting a 2D converged beam from the edge (end-fire) requires a true 3D OPA on the edge side. In [A. Hosseini, D. Kwong, Y. Zhang, S. A. Chandorkar, F. Crnogorac, A. Carlson, B. Fallah, S. Bank, E. Tutuc, J. Rogers, R. F. W. Pease, R. T. Chen, On the Fabrication of Three-Dimensional Silicon-on-Insulator Based Optical Phased Array for Agile and Large Angle Laser Beam Steering Systems. Jour. of Vac. Sci. & Tech. B 28, C6O1 (2010)], the idea of a true 3D OPA is firstly proposed; the performance of an end-fire OPA with a multi-waveguide-layer configuration is numerically discussed, and the method utilizing nanomembrane transfer printing to fabricate a multi-layer structure with the top Si layer from an SOI wafer is proposed.

In the realm of photonics, there is a notable distinction between devices described as 3D and those characterized as “true 3D” when referencing optical phased arrays (OPAs) or photonic integrated circuits (PICs). A 3D OPA or PIC typically has a design that looks three-dimensional. This appearance often results from processes that layer different 2D planes on top of each other, giving the device a 3D structure. However, from a functional perspective, these 3D devices might still operate primarily on one or two planes, meaning that even though they have a 3D structure, they might not exploit the full spatial potential that the third dimension offers. On the other hand, a “true 3D” OPA or PIC doesn't just stop at having a three-dimensional appearance. Beyond its structure, it actively utilizes all three spatial dimensions for its operational capabilities. For instance, a true 3D OPA can steer light beams along or within any dimension(s) of its three-dimensional space, without being limited to a single plane or axis. Achieving this kind of functionality requires not only a more sophisticated design, but also advanced fabrication techniques that can intricately mold and control structures throughout the entire volume of the device.

In [B. Guan, C. Qin, R. P. Scott, B. Ercan, N. K. Fontaine, T. Su, S. J. B. Yoo, Hybrid 3D Photonic Integrated Circuit for Optical Phased Array Beam Steering. CLEO, (2015)], a direct writing method based on ultrafast laser inscription (ULI) is applied to achieve the conversion between single-layer waveguides and 3D waveguides in the structure. A 3D OPA can be formed so as to have a two-dimensional emitter array on the edge side, especially with the current CMOS compatible 3D circuitry on-chip [W. R. Davis, J. Wilson, S. Mick, J. Xu, H. Hua, C. Mineo, A. M. Sule, M. Steer, P. D. Franzon, Demystifying 3D ICs: The Pros and Cons of Going Vertical. IEEE Des. and Test of Com. 5, 498 (2005), referred to herein as “W. R. Davis et al.”]. This is the first reason that a multi-waveguide-layer configuration is helpful in an OPA device.

A major issue for optical efficiency occurs at the input coupling end. In most OPA studies, researchers considered using an external light source such as a pulsed or coherent laser. In such a case, fiber is needed to connect the light source and the OPA chip. Research shows that the frequency of light is usually utilized as one degree of freedom in either beam steering or distance detection (in the case of an FMCW Lidar). Therefore, a wideband coupling performance is desired for the fiber-to-chip coupler. Similarly, at the emitting end, the two standard coupler designs also have their issues: the edge coupler shows a wideband performance but usually suffers a significant coupling loss due to the mode mismatch between the single-mode fiber and the on-chip waveguide (which is generally at least one order smaller in size than the fiber); the grating coupler can offer a much better mode match, which leads to a high coupling efficiency, but only at a relatively narrower band. To address this issue, wideband high-efficient couplers have been designed by applying additional waveguide layers (usually Si₃N₄ layers) on top of the silicon waveguide layer. These couplers allow the fiber mode to be first coupled to a super-mode in the nitride stack, then gradually coupled to the silicon waveguide by evanescent coupling.

### SUMMARY

According to a first aspect of the invention, there is provided an optical phased array device having a plurality of self-aligned waveguides having an on-chip edge coupler at which a single mode optical fiber is coupled to each of the plurality of self-aligned waveguides.

According to other aspects of the invention, the optical phased array device of the first aspect further includes any of the following features, including any technically-feasible combination of the following features:
the plurality of self-aligned waveguides is four or more self-aligned waveguides;
the plurality of self-aligned waveguides is eight or more self-aligned waveguides;
the on-chip edge coupler includes a fiber coupling interface that is used to couple to an optical fiber to the plurality of self-aligned waveguides;
a plurality of optical fibers including the optical fiber is coupled to each of the plurality of self-aligned waveguides via the fiber coupling interface;
the plurality of optical fibers is configured as a bunched fiber array in which the plurality of optical fibers and the plurality of self-aligned waveguides are stacked along the same direction;
the optical fiber is coupled to each of the plurality of self-aligned waveguides via the fiber coupling interface;
the optical fiber is a multi-mode optical fiber; and/or
the fiber coupling interface is configured to couple a common edge portion for each of the plurality of waveguide layers to a single mode optical fiber, and wherein the common edge portion for each of the plurality of waveguide layers are each a part of the common edge.

According to a second aspect of the invention, there is provided an optical phased array device having a plurality of self-aligned waveguides having an on-chip edge coupler at which a single mode optical fiber is coupled to each of the plurality of self-aligned waveguides.

According to other aspects of the invention, the optical phased array device of the second aspect further includes any of the following features, including any technically-feasible combination of the following features:
the fiber coupling interface is configured to couple a common edge portion for each of the plurality of waveguide layers to a single mode optical fiber, and wherein the common edge portion for each of the plurality of waveguide layers are each a part of the common edge;
the plurality of waveguide layers includes a plurality of self-aligned waveguides, and wherein the plurality of waveguide self-aligned waveguides includes four or more self-aligned waveguides;
the plurality of self-aligned waveguides is six or more self-aligned waveguides;
the plurality of self-aligned waveguides is eight or more self-aligned waveguides; and/or
a total number of waveguide layers of the optical phased array is between six and eight, inclusive.

According to a third aspect of the invention, there is provided a method of fabricating an optical phased array device. The method includes: fabricating an optical phased array according to a layer thickness for one or more waveguide layers, wherein the layer thickness is determined based on mode matching data derived from a mode profile at an input coupling interface.

According to other aspects of the invention, the optical phased array device of the second aspect further includes any of the following features, including any technically-feasible combination of the following features:
a process of determining fabrication properties for the optical phased array to be fabricated is performed, and wherein the process includes: determining the layer thickness for the one or more waveguide layers based on the mode matching data derived from the mode profile at the input coupling interface; and/or
the layer thickness is determined based on a number of waveguide layers that are to be fabricated for the optical phased array, and wherein the number of waveguide layers is greater than one.

According to another aspect of the invention, there is provided a method of determining fabrication properties for an optical phased array to be fabricated, comprising: determining a layer thickness for one or more waveguide layers based on mode matching data derived from a mode profile at an input coupling interface. According to a further aspect, this method of determining fabrication properties is further characterized by any one or technically-feasible combination of the features recited in connection with the other aspects noted above. Further, according to yet one further aspect, the layer thickness is determined based on a number of waveguide layers that are to be fabricated for the optical phased array, and wherein the number of waveguide layers is greater than one.

According to a further aspect, the optical phased array device of the first aspect is further characterized by any one or technically-feasible combination of the features recited in connection with the other aspects noted above.

According to a further aspect, the optical phased array device of the second aspect is further characterized by any one or technically-feasible combination of the features recited in connection with the other aspects noted above.

According to a further aspect, the method of the third aspect is further characterized by any one or technically-feasible combination of the features recited in connection with the other aspects noted above.

### BRIEF DESCRIPTION OF THE DRAWINGS

Preferred exemplary embodiments will hereinafter be described in conjunction with the appended drawings, wherein like designations denote like elements, and wherein:

FIG. 1 is a block diagram depicting an embodiment of a three-dimensional (3D) OPA device having an OPA with an on-chip edge coupler, according to at least one embodiment;

FIG. 2 is a block diagram depicting an embodiment of the OPA includes a Silicon-based structure, which may be a Silicon-on-insulator (SOI) platform having a plurality of Silicon-based two-dimensional (2D) waveguide arrays, according to at least one embodiment;

FIGS. 3A and 3B are side views of an exemplary 3D OPA having four waveguide layers that may be used as the OPA of the OPA device of FIG. 1, according to at least one embodiment;

FIG. 4 is a plan view, block diagram of the OPA of FIG. 2 with an expanded portion of the tree splitter or multimode interferometer (MMI), according to at least one embodiment;

FIG. 5 is a plan view, block diagram of the OPA of FIG. 4 with an expanded portion of a phase delay modulator or phase shifter portion is shown in which the waveguide paths each follow an omega-shaped delay path, according to at least one embodiment;

FIG. 6 is a schematic isometric view of an embodiment of an eight-layer 3D edge-firing OPA, showing a single mode fiber (SMF) coupling light into the device and a 2D 8×16 emitter array formed at the edge of the device, according to at least one embodiment;

FIG. 7 is a sequence of end views for a layer-by-layer 3D OPA during the layer-by-layer fabrication process, according to at least one embodiment;

FIG. 8 is an end view of the layer-by-layer 3D OPA after the layer-by-layer fabrication process, showing potential issues of uneven thickness and misalignment between layers, according to at least one embodiment;

FIG. 9 is a flowchart illustrating an exemplary method of fabricating a 3D OPA using a simultaneous-lithography process to produce a self-aligned, according to at least one embodiment;

FIG. 10 shows a 3D edge-firing OPA throughout five different stages during a single lithography fabrication process, according to at least one embodiment;

FIGS. 11-17 depict mode profiles using different polarizations (TE polarization and TM polarization) at different portions of the OPA device, including at the optical fiber (FIGS. 12 and 15), in the waveguide layer of the OPA before tapering (FIGS. 13 and 16), and in the waveguide layer of the OPA after tapering (FIGS. 14 and 17), according to at least one embodiment;

FIG. 18 is a graph illustrating results of sweeping for optimal coupler width to achieve the best or improved coupling efficiency between a fiber and a waveguide, according to at least one embodiment;

FIG. 19 is a graph illustrating sweeping results of the taper length, according to at least one embodiment;

FIGS. 20A and 20B illustrate the mode propagation within the input coupler, with FIG. 20A showing the side-view cross-section where light propagates individually along each of the eight layers at 1550 nm, and FIG. 20B depicting the top-view cross-section that demonstrates the mode size conversion between the fiber and the single-mode waveguide, optimized by layer thickness selection for efficient coupling, according to at least one embodiment;

FIG. 21 is a graph illustrating simulated coupling efficiency across the 1500 nm to 1600 nm wavelength range, showing a maximum efficiency of 71.70% at 1515 nm with only 0.58% variation over the entire range, without anti-reflection coating, according to at least one embodiment;

FIG. 22 is a graph illustrating experimental results for input coupling efficiency, comparing 1-layer and 4-layer waveguide devices in the C+L wavelength band (1530 nm to 1600 nm), according to at least one embodiment;

FIG. 23 shows the vertical cross-section of a 1-layer sample, comparing the simulated smooth-shaped curve and the experimentally tested curve, according to at least one embodiment;

FIG. 24 shows the vertical cross-section of a 4-layer sample, displaying both the simulated and tested results, according to at least one embodiment;

FIG. 25 is a graph demonstrating beam steering capabilities from 4-layer devices, showing different steering angles for delay lengths of 20 μm, 40 μm, and 60 μm, according to at least one embodiment;

FIG. 26 illustrates a multi-layer Optical Phased Array (OPA) device with electrical contacts, showing that individual phase shifters are applied to each waveguide, enabling 2D beam steering and the potential use of multimode fibers for power input, according to at least one embodiment; and

FIG. 27 is a plan view, block diagram of a waveguide layer for a multi-layer OPA device is shown in this figure, highlighting independent waveguide paths with phase shifters controlled by electrical contacts, and coupled to a multimode optical fiber for efficient light transmission, according to at least one embodiment.

### DETAILED DESCRIPTION

The system and method described herein enables fabricating an optical phased array (OPA) device having an OPA comprised of a plurality of self-aligned waveguides that has a waveguide edge coupling region (referred to also as an on-chip edge coupler) that is configured to be coupled to an optical fiber. The waveguide edge coupling region corresponds to a portion of a surface at which the plurality of self-aligned waveguides terminate; at least in embodiments, the waveguide edge coupling region is circular in cross-section so as to complement an axial end of the optical fiber to which it is to be coupled. At least in some embodiments, each waveguide layer of the plurality of self-aligned waveguides is planar and defines a waveguide path carrying light from one edge or end to another edge or end; in such embodiments, the waveguide edge coupling region may be defined to include a portion of edge whereat the waveguide path terminates (at the active or transmissive portion) for each of the waveguide layers. The OPA device may further include an optical fiber and the on-chip edge coupler, where the on-chip edge coupler provides a coupling interface for the optical fiber and the waveguides of the waveguide layers, whereat light passes between the optical fiber and the waveguides. According to embodiments, for an OPA that is to be fabricated (referred to as a “target optical phased array” or “target OPA”), fabrication properties are determined based on a number of waveguide layers and/or mode matching data that is determined based on a mode profile at the on-chip edge coupler. Enhanced mode matching is achieved through use of self-alignment fabrication whereby multiple waveguide layers are simultaneously etched so as to achieve very precise alignment of the respective waveguides within the waveguide layers. This self-alignment effectively enables more suitable mode matching between the optical fiber and the waveguide layers so as to minimize vertical crosstalk while also mitigating Fresnel reflection effects, at least in embodiments.

The on-chip edge coupler may be suitably configured so as to accommodate the number of waveguide layers while also having desirable or sufficient mode matching properties. This may be achieved by the optical array fabrication process, which includes: determining a number of waveguide layers for a target optical phased array; determining edge coupler properties based on the number of waveguide layers, such as whether to use a single mode or multimode fiber; and fabricating the optical phased array, including coupling an input end of the optical phased array (at which the plurality of self-aligned waveguides start) to an optical fiber.

The on-chip edge coupler may be used to offer stable efficiencies in a broad bandwidth. However, in the particular case of OPA devices, trivially applying the edge coupler will result in two disadvantages: (1) a mode mismatch at the input end, and (2) a beam with only one-dimensional (1D) convergence at the emitting end. The disclosed system and method address both disadvantages, such as, for example, through taking advantage of building photonic integrated circuit (PIC) in 3D [W. R. Davis et al.], based on a Si₃N₄/SiO₂ platform, and achieving distinct characteristics, such as: (a) vertical multiple-layers providing a broadband high power coupling efficiency to a 2D converged beam; and/or (b) omega-shape (Ω-shape) design purposely creates an extra dispersion effect, which enables an unlimited beam steering capability in principle—as a result, according to one embodiment and implementation, the highest proven beam steering is 0.577°/1 nm wavelength in the 4-layer sample with 60 μm delay length, and this differs from all other standard 2D approaches leveraging grating couplers to synthesize 3D beams. As proof of concept, experimental fabrication of the multilayer OPAs was performed and verified with careful characterization.

Although 3D OPAs provide extended functionality, such OPAs must be operated within certain constraints in order to suitably carry out their intended functionality, and proper interfacing between an input fiber (carrying light from a light source) and the OPA is used to achieve desired output results.

As mentioned above, mode matching between the optical fiber and the waveguides at the on-chip edge coupler is facilitated through precision in the fabrication process. Accordingly, in embodiments, the OPA is fabricated using a collective lithography step in which multiple waveguide layers are etched simultaneously. According to embodiments, the collective lithography step includes performing a vertical or orthogonal dry etching on a waveguide-cladding stack of alternating waveguide and cladding layers. The collective lithography step results in an etched waveguide-cladding stack with a plurality of waveguides having waveguide paths shaped according to the pattern etched during the collective lithography step. The etched waveguide-cladding stack is then covered with a cladding deposition layer that at least partly envelopes the etched waveguide-cladding stack. According to embodiments, dry reactive ion etching (RIE) is used to etch precise vertical cuts so that the same pattern is maintained for each of the etched layers during the collective lithography step.

The plurality or set of waveguide paths of the edge-firing OPA terminate at a common end or edge at which light is (or other electromagnetic waves are) emitted and, thus, such OPAs are referred to as edge-firing. The set of waveguide paths terminate at the common end or edge (collectively, referred to as “common edge” corresponding to a “collector side surface”), and the ends or terminal portions of each waveguide path are spaced apart along a first axis, which is considered to extend in a first dimension. In embodiments, the spacing may be set according to a waveguide pattern and this waveguide pattern may be periodic or aperiodic, which means that the spacing between adjacent elements is uniform (periodic) or non-uniform (aperiodic) throughout. Thus, according to at least some embodiments, each waveguide path of the set of waveguide paths ends at the common edge where electromagnetic radiation (referred to herein simply as “light”) is emitted and leaves the OPA—these end or terminal portions of the waveguide paths from which light is emitted are referred to as “firing end portions” and “edge emitters.” The set of waveguide paths receive light from a light source that is coupled to the optical phased array.

According to at least some embodiments, the OPA device includes the OPA, the light source, a light sensor, and a controller. The light source is coupled to the optical phased array so that light may be transmitted through the set of waveguide paths of the OPA, and the light sensor is coupled to the OPA so that the light sensor may receive light impinged on the OPA. The controller is operatively coupled to the light source so as to control generation and emission of light by the light source and is operatively coupled to the light sensor so as to determine information based on the light received at the light sensor. In embodiments, the controller includes at least one processor and memory accessible by the at least one processor, and the memory stores computer instructions that, when executed by the at least one processor, cause the OPA device to operate, including transmitting light from the OPA and/or processing information concerning light received at the OPA.

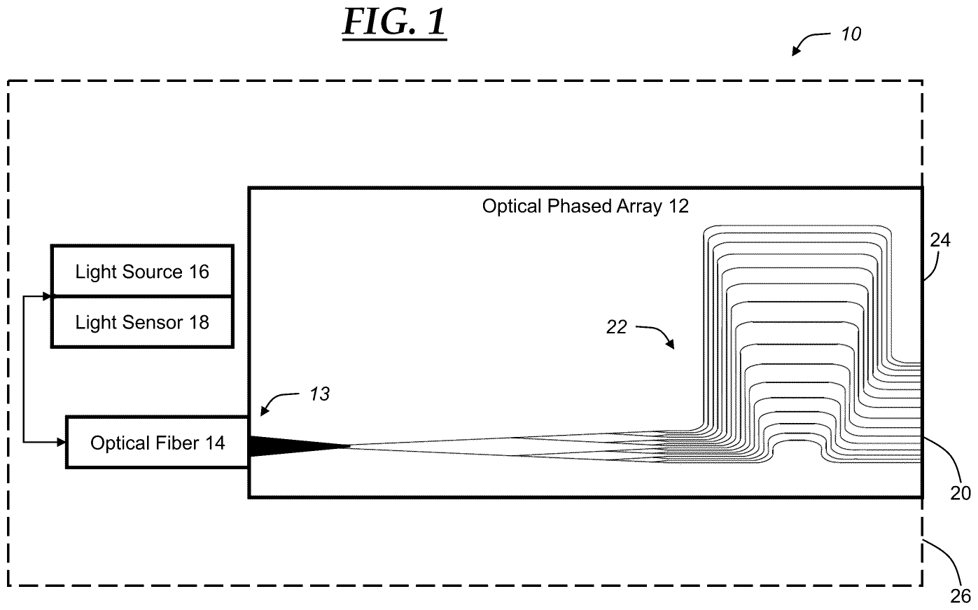

With reference to FIG. 1, there is shown an embodiment of a three-dimensional (3D) OPA device 10 having an OPA 12 with an on-chip edge coupler 13, and the OPA device 10 of the present embodiment further includes an optical fiber 14, a light source 16, and a light sensor 18. An OPA device is a device that has an OPA. The OPA device 10 may be used for a variety of different applications according to various embodiments, such as, for example, a solid-state lidar device, or, for a variety of purposes, as a part of a photonic integrated circuit (PIC). In at least some embodiments, the OPA device 10 may be used for two-dimensional and/or three-dimensional lidar applications, and/or may enable solid state scanning through varying the time delay of emitted light generated from a coherent light produced by the light source 16, for example. It will be appreciated that the depiction of the OPA device 10 in FIG. 1 is diagrammatic and that the OPA device may be incorporated into another device or apparatus, and may be a part of a larger system.

The OPA 12 is shown as being operatively coupled to the light source 16 and the light sensor 18, and may be used to transmit light generated or provided by the light source 16 and to receive light impinged at the OPA 12 at the light sensor 18. The OPA 12 is an edge-firing OPA in that it includes a plurality of edge emitters 20 that are disposed at an edge of a planar, plate-shaped structure, such as a Silicon-based wafer having a plurality of waveguide layers thereon. The OPA 12 may employ a Silicon-based waveguide structure forming a waveguide array and having a Si₃N₄ pattern layer and a SiO₂ base layer, such as that which is disclosed in U.S. Patent Application Publication No. 2021/0271148 A1, the entire contents of which are hereby incorporated by reference and attributed to the OPA 12 to the extent it is not inconsistent with the discussion herein.

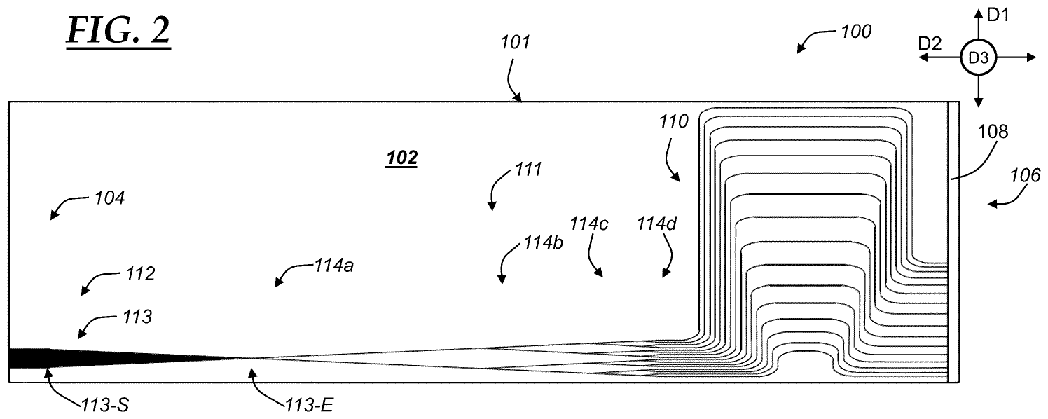

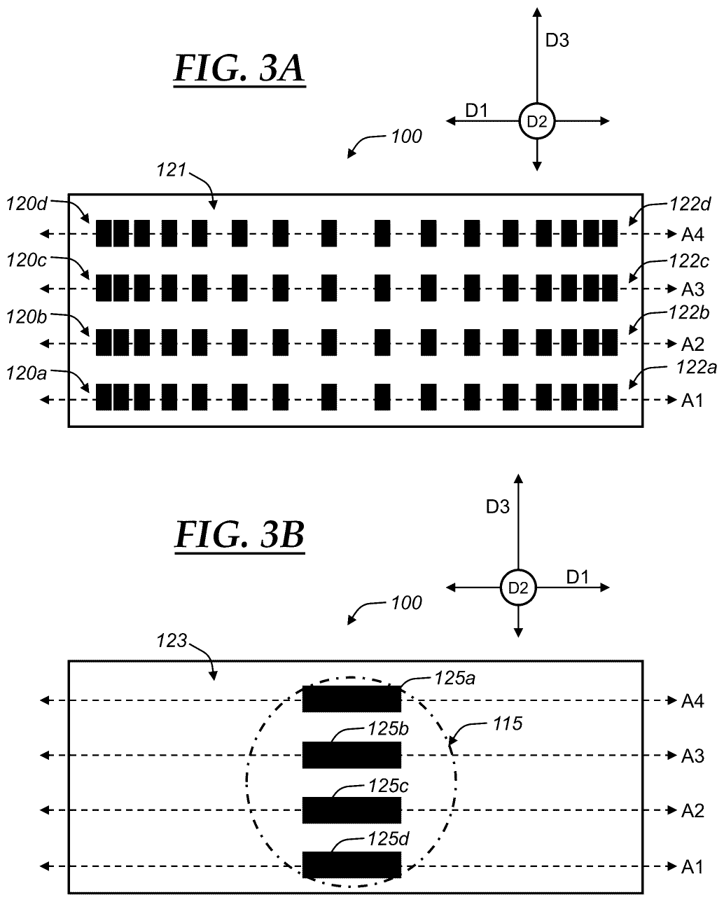

The on-chip edge coupler 13 is used to couple the optical fiber 14 to the OPA 12, and includes a waveguide edge coupling region 15. The waveguide edge coupling region 15 is a region or portion of a surface of an edge or peripheral side of the OPA 12. As used herein, a “peripheral side” of an OPA refers to a side that is comprised of an edge of each of a plurality of waveguide layers comprising the OPA, and this feature is discussed in more detail below with respect to waveguide edge coupling region 115 (FIG. 3B) of OPA 100, as discussed below with regard to FIGS. 2-6.

With reference still to FIG. 1, the plurality of edge emitters 20 may be comprised of terminal portions of waveguide paths 22 disposed within a waveguide array of the OPA 12. The edge emitters 20 are disposed at a common edge 24 and are spaced apart from one another in a first dimension D1, which is discussed more below in connection with the OPA 100 of FIGS. 2-6. The common edge 24 is disposed on a peripheral side of the OPA 12. The waveguide paths 22 are shown schematically in FIG. 1 as extending from the light source 16 and light sensor 18 to the edge emitters 20; the depiction of the waveguide paths in FIG. 1 is for purposes of showing which elements are operatively coupled to one another and not for showing actual physical locations, configurations, or shapes of the waveguide paths, which may take a different form, such as that which is shown in FIG. 2 below. While various coupling mechanisms and techniques may be used for coupling the OPA 12 to the optical fiber 14, the on-chip edge coupler 13 discussed herein is configured to facilitate engagement of an axial end of the optical fiber 14 and the waveguide paths 22 of the OPA 12 in a manner that results in enhanced mode matching and transmission efficiencies and effects. In embodiments, enhanced mode matching and other positive transmission efficiencies and effects are had through enforcement of low fabrication tolerances in the construction of the multi-waveguide-layered OPA 12. According to embodiments, for purposes of achieving such low fabrication tolerances, self-aligned waveguide layers are constructed using the self-aligned waveguide layer fabrication process discussed herein, and this results in an OPA having waveguide layers that are very closely aligned and/or precisely positioned relative to one another.

The waveguide edge coupling region 15 is comprised of an end of each of the waveguide layers, and includes both transmissive (corresponding to active portions of the waveguide) and non-transmissive portions (corresponding to non-active portions, such as surrounding cladding). The waveguide paths 22 each provide a path through which light is able to travel so that light provided by the light source 16 may be emitted by the edge emitters 20 of the OPA 12. And, at least in some embodiments, the waveguide paths 22 each provide a path through which light is able to travel so that light impinged on the edge emitters 20 of the OPA 12 is received at the light sensor 18.

In embodiments, the components 12-18 of the OPA device 10 may be disposed on a common substrate 26, which may be a printed circuit board, according to one embodiment. In other embodiments, the components 12-18 may be arranged or disposed on different substrates and/or housed in different housings, for example.

With reference to FIGS. 2-6, there is shown an exemplary 3D OPA 100 having four waveguide layers 120a-d (FIGS. 3A-B) that may be used as the OPA 12 of the OPA device 10. It will be appreciated that FIGS. 2-5 indicate orientation relative to three dimensions, a first dimension D1, a second dimension D2, and a third dimension D3, which are all orthogonal to one another and that may correspond to X, Y, and Z axes, respectively.

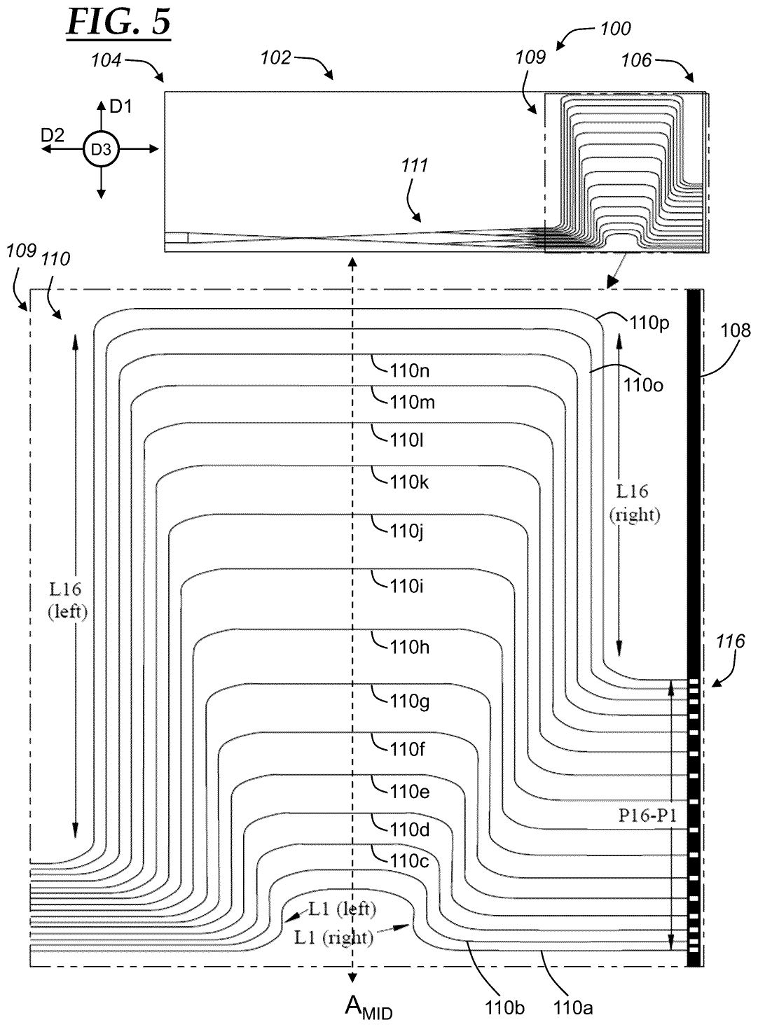

FIGS. 3A-B each diagrammatically depicts a side or peripheral plan view (i.e., view with a peripheral side in plan view) of the 3D edge-firing OPA 100, along with the four waveguide layers 120a-d, each of which corresponds to a row of edge emitters 122a-d (which correspond to the edge emitters 20 of FIG. 1). Each row of edge emitters 122a-d extends along a waveguide layer axis A1,A2,A3,A4, respectively, extending in the first dimension D1 and aligned to pass through a center of the respective edge emitters 122a-d taken in the third dimension D3. As will be appreciated, each row of edge emitters 122a-d is considered a set of the individual edge emitters 116 (FIG. 5).

FIG. 3A depicts an emitter side surface 121 of the OPA 100 and FIG. 3B depicts a collector side surface 123 of the OPA 100, where the emitter side surface 121 and the collector side surface 123 are opposed from one another so that light travels between the two surfaces 121,123 through the waveguide layers 120a-d.

FIG. 3B illustrates the collector side surface 123 in plan view, which has a waveguide edge coupling region 115 shown as constituting a circular region of the collector side surface 123. The waveguide edge coupling region 115 includes transmissive portions 125a-d of each of the waveguide layers 120a-d, which are used to transmit light between the waveguide edge coupling region 115 to which the optical fiber 14 is to be coupled and the row of edge emitters 122a-d. In embodiments, the side surfaces, such as the emitter side surface 121 and the collector side surface 123 of the OPA 100, are polished so as to remove errant fabrication artifacts; and, in some embodiments, particular attention is paid to the waveguide edge coupling region 115, notably for forming a smooth, planar surface. The waveguide edge coupling region 115 corresponds to a fiber coupling interface (also referred to as an input coupling interface) between the optical fiber 14 and the collector side surface 123.

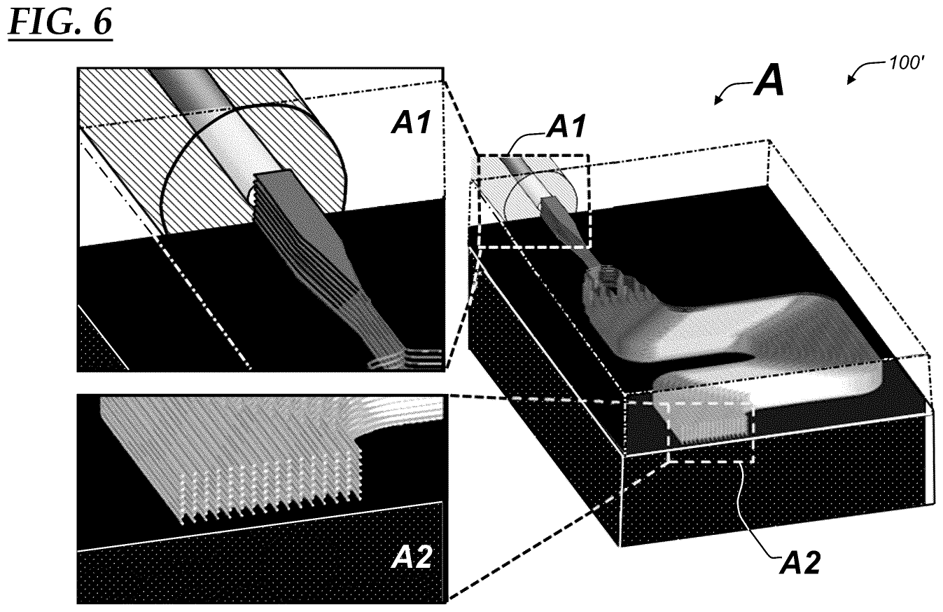

FIG. 6 represents one embodiment of an eight (8) layer 3D edge-firing OPA 100′ that is similar to the four-layer 3D OPA 100 of FIGS. 3A-B, but with eight layers. In particular, in FIG. 6 at “A”, there is shown a schematic isometric view of the OPA structure where a single mode fiber (SMF) is used to couple light into the device, and the waveguide width at the coupling region is enlarged to ensure the best mode matching (see zoomed-in portion A1); FIG. 6 also depicts a 2D 8×16 emitter array of the 3D OPA 100′ formed at the edge of the device (see zoomed-in portion A2). Of course, in other embodiments, the OPA may have a different number of layers and/or emitters, employing any of a variety of M×N configurations where M is the number of emitter rows (or number of waveguide-cladding layers) and N is the number of emitter columns (or number of waveguide paths within a waveguide-cladding stack). Although the description below discusses the construction and operation of the OPA 100, it will be understood that the description applies also to other OPA embodiments, including the OPA 100′ of FIG. 6.

With specific reference now to FIG. 2, the OPA 100 includes a Silicon-based structure 101, which may be a Silicon-on-insulator (SOI) platform having a plurality of Silicon-based two-dimensional (2D) waveguide arrays 102, and each waveguide array 102 has a collector side 104 and an emitter side 106 disposed on an opposite side of the waveguide array 102 from the collector side 104. The Silicon-based structure 101 may include a Silicon wafer and the plurality of 2D waveguide arrays 102 so as to constitute a 3D OPA.

The collector side 104 is configured to be coupled to a light source and a light sensor, such as the light source 16 and the light sensor 18 when used as the OPA 12 in the OPA device 10. The waveguide array 102 includes an edge 108 that extends in the first dimension D1, which is orthogonal to a second dimension D2. The OPA 100 includes a plurality or a set of waveguide paths 110 that extend generally in the second dimension D2 from the collector side 104 to the emitter side 106. In particular, the set of waveguide paths 110 start at the collector side 104 and all are formed of a single or common path 112, which first is tapered at tapered portion 113 and then splits or branches in a binary fashion multiple times so that sixteen waveguide paths 110 are generated. The tapered portion 113 extends in a direction from the collector side 104 to the emitter side 106, beginning at a taper start 113-S and ending at a taper end 113-E. The taper start 113-S has a width (measured in the first direction D1, and referred to as a “taper start width”) that is larger than the width of the taper end 113-E (measured in the first direction D1, and referred to as a “taper end width”).

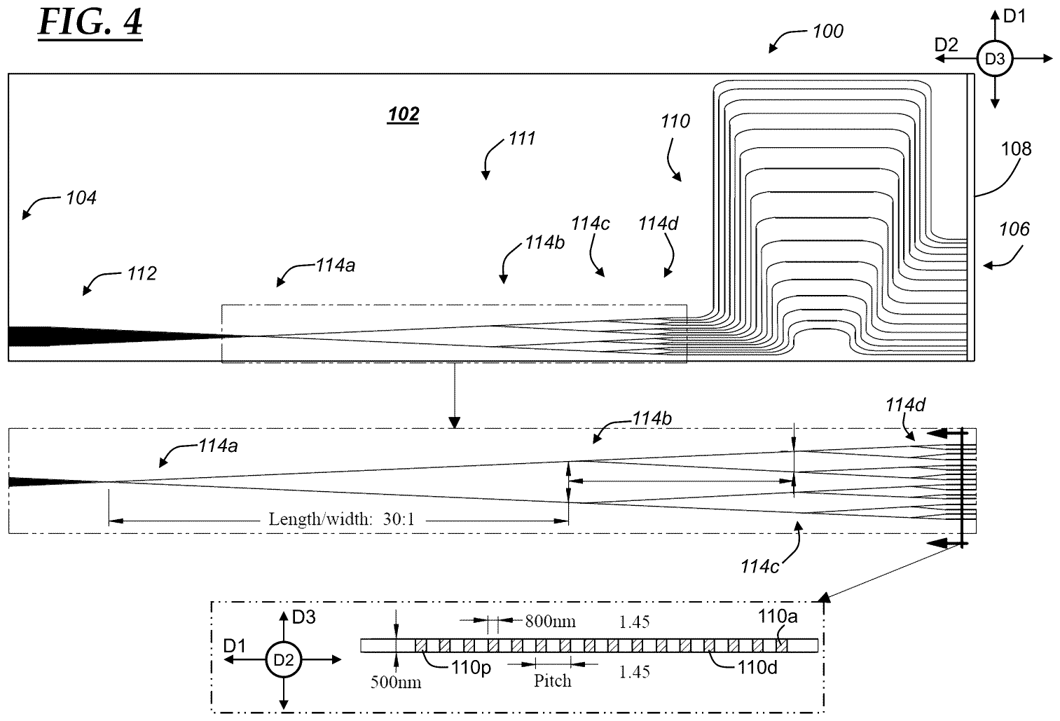

The waveguide paths 110 may each be formed as a 1×N multimode interferometer (MMI) 111 where N is the number of waveguide paths, which is sixteen in the depicted embodiment; specifically, in the embodiment depicted in FIGS. 2-4, each waveguide path 110 begins as a part of the common path 112 and then are split four times, at a first binary split (bifurcation) or branching portion 114a, a second binary split or branching portion 114b, a third binary split or branching portion 114c, and a fourth binary split or branching portion 114d, so as to yield sixteen unique waveguide paths 110a-p, as shown in FIG. 4. In other embodiments, a different number N of waveguide paths may be used.

With reference now specifically to FIG. 4, there is shown a plan view of the OPA 100 with an expanded portion of the tree splitter or MMI 111, which includes the four binary branching portions 114a-d. As shown in the cross-sectional portion of FIG. 3, which is taken at an emitter-side end of the tree splitter 111 where the waveguide paths have been finally split into N separate paths/branches, the height of the waveguide paths 110, taken in the third dimension D3, is 500 nm and the width (taken in the first dimension) of each waveguide path 110a-p is 800 nm. At this portion, each of the waveguide paths 110a-p are separated by a uniform pitch, which may be 2 μm for example; of course, in other embodiments, the pitch may be larger or smaller, such as, for example, 2 μm+/−1.5 μm and/or 2 μm+/−500 nm.

With reference now specifically to FIG. 5, an expanded portion of a phase delay modulator or phase shifter portion 109 is shown in which the waveguide paths 110 each extend in a first direction of the second dimension D2 (from the left to right side of FIG. 4) from the tree splitter 111, then extend in a first direction of the first dimension D1 for a length (referred to as a “first leg length”) (such as is indicated at L1 (left) for waveguide path 110a and L16 (left) for waveguide path 110p), then extend in the first direction of the second dimension D2, then in a second direction of the first dimension D1 that is opposite the first direction of the first dimension D1 for a length (referred to as a “second leg length”) (such as is indicated at L1 (right) for waveguide path 110a and L16 (right) for waveguide path 110p), and finally in the first direction of the second dimension D2 at which the waveguide paths 110a-p each end at a respective one of the emitters 116; this configuration is referred to as an omega (52) shaped phase delay configuration. According to one embodiment, the first leg length L1 (left) of the first waveguide path 110a is 5 μm and the second leg length L1 (right) of the first waveguide path 110a is 5 μm. The right-angle or 90 degree turns between the first and second dimensions, as shown in the expanded portion of FIG. 5, may each be rounded in a circular manner with a predetermined radius of curvature, such as, for example, 8 μm; in other embodiments, a smaller or larger radius of curvature may be used, such as, for example, 8 μm+/−4 μm and, preferably in some embodiments, 8 μm+/−1 μm.

As shown in FIG. 5, an axis AMID in the first dimension extends through a middle portion of the phase delay modulator or phase shifter portion 109. In at least one embodiment, spacing along this axis AMID is aperiodic such that spacing, in the first dimension, between adjacent waveguide paths is not uniform; this is different from the uniform spacing that is present at the beginning of the phase delay modulator or phase shifter portion 109, which is shown best in cross-section in FIG. 4. In other embodiments, uniform spacing may be used along the axis AMID.

Within the phase delay modulator portion 109, each waveguide path 110a-p has an omega-shaped delay configuration, such as that which is shown in FIG. 5 and described above. In some embodiments, one or more of the waveguide paths 110a-p does not have an omega-shaped delay configuration, such as the first waveguide path 110a, which may simply be a straight path extending in the second dimension D2 from the tree splitter 111 to a first one of the emitters 116; in such embodiments, each of the other waveguide paths 110a-p may have an omega-shaped delay configuration. Each of the waveguide paths 110a-p ends or terminates at the edge 108 at a firing portion at which light is emitted and this portion may be referred to as an edge emitter 116.

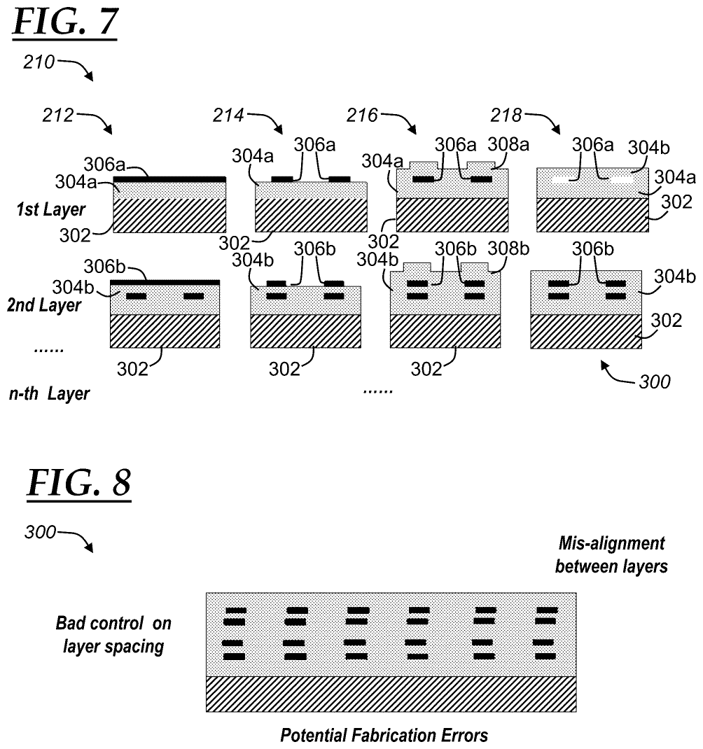

With reference to FIGS. 7-8, there is shown a layer-by-layer fabrication process for fabricating a layer-by-layer 3D OPA 300; in particular, FIG. 7 depicts a sequence of end views for the layer-by-layer 3D OPA during the layer-by-layer fabrication process, and FIG. 8 depicts the layer-by-layer 3D OPA from an end view after the layer-by-layer fabrication process. The layer-by-layer fabrication involves producing individual waveguide layers one at a time by iteratively performing a complimentary metal-oxide semiconductor (CMOS) fabrication process that uses chemical mechanical planarization (CMP). Although possibly suitable for some OPA uses, as discussed below, this layer-by-layer approach causes uneven thickness of layers and/or misalignment between the layers, for example, where the waveguide paths are not accurately coextensive within the first dimension D1 and the second dimension D2.

Generally, the layer-by-layer fabrication process progresses in a layer-by-layer manner, which means that layers of the 3D OPA to be fabricated are deposited one layer at a time such that the layer-by-layer fabrication process includes a separate etching step for each waveguide layer such that the waveguide layers are not etched simultaneously. Indeed, the layer-by-layer fabrication includes generating a waveguide-cladding layer that includes a waveguide layer and a cladding layer; this step is referred to as a waveguide-cladding layer generation step. The waveguide-cladding layer generation step or operation 210 includes: waveguide layer deposition 212, patterning 214, cladding layer deposition 216, and surface polishing 218. More particularly, the waveguide layer deposition 212 is performed in order to deposit waveguide material onto a (first) base cladding layer 304a, which rests upon a base substrate 302; this results in generation of a (first) waveguide layer 306a. The first waveguide layer 306a is then patterned and a cladding layer 308a is deposited onto the patterned waveguide layer 306a, as shown at 216. Then, at 218, CMP is used to planarize or polish the top surface and this cladding layer 304b is used as the next base layer 304b for the next waveguide-cladding layer.

FIG. 7 shows that, in this layer-by-layer process, a whole layering-patterning-cladding-polishing cycle is needed for every layer of the waveguides, and this is consistent with the back-end process in the electronic integrated circuit (IC) industry, which fabricates the interconnection metal layers. In electronic integrated circuits (EICs), it may not be necessary to have precise control over the layer spacing and the alignment between layers; however, in photonic integrated circuits (PICs), especially in the OPA devices, these two issues can negatively impact the phase profile at the emitting surface and cause a distorted farfield pattern.

FIG. 8 illustrates an example of a layer-by-layer OPA that can result from the fabrication process of FIG. 7. As shown therein, the process may result in a OPA having undesirable emitter spacing in either or both of the D1 and D3 directions. This can be due to the potential fabrication errors noted above, including the depicted variation of layer spacing and the depicted misalignment between layers. In most OPA applications, a good emitting farfield pattern relies on the accurate arrangement of the array. In a Si 3D OPA, the waveguide core size is typically around 300 nm to 500 nm, in such a case, a 10% fabrication error will be around 30 to 50 nm, and it may not be acceptable. In a Si₃N₄ 3D OPA, the fabrication tolerance is slightly relieved, but still in the range of around 100 nm (˜10% feature size), at least in embodiments. In this layer-by-layer CMOS compatible fabrication process, such a low fabrication tolerance is challenging in either the layer spacing control (relying on the thickness control during a CMP process) or the alignment between layers (relying on the calibration between multiple exposures).

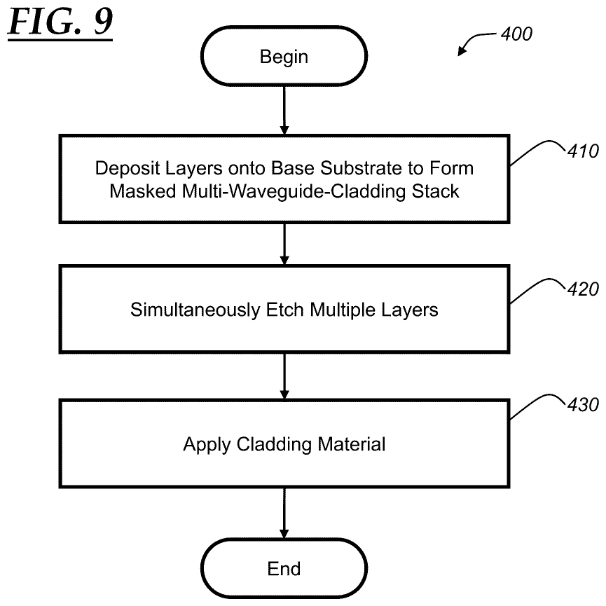

One method to address one or both of these two issues is using a simultaneous-lithography process over multiple waveguide layers to produce a self-aligned OPA rather than the OPA of FIGS. 7 and 8. FIG. 9 illustrates an exemplary method 400 of fabricating a 3D OPA, which includes, namely, simultaneously etching multiple layers of a waveguide-cladding stack to form a plurality of waveguide paths, each of which terminates at a common edge. Thus, this exemplary method 400 includes directly patterning multiple waveguide layers together instead of patterning one waveguide layer at a time. This process 400 is useful when multiple waveguide layers are to contain the same pattern (or at least a portion of the whole pattern to be the same); fortunately, this is often the case with OPA devices. In this process, the layer spacing is controlled by CVD, which has very good control over the thickness (the accuracy can be smaller than 10 nm); and because of the simultaneous-lithography process, the waveguide layers are self-aligned. In embodiments, the OPA 100, as well as the OPA 100′ shown in FIG. 6, are fabricated using the method 400.

The method 400 begins with step 410, wherein layers are deposited onto a base substrate to form a multi-waveguide-cladding stack. A multi-waveguide-cladding stack is a waveguide-cladding stack having multiple waveguide-cladding layers. A waveguide-cladding layer refers to a waveguide layer accompanied by a cladding layer. As shown at 1510, a waveguide-cladding blank 600 includes a base substrate 602 and a masked multi-waveguide-cladding stack 604 supported by the base substrate 602 and having a multi-waveguide-cladding stack 606 and a mask layer 608. The multi-waveguide-cladding stack 606 includes a plurality of waveguide-cladding layers 610 and are individually referred to by 610-n, where n represents the index of the waveguide-cladding layer with the first waveguide-cladding layer being denoted 610-1, for example, and N represents the number of waveguide-cladding layers. The multi-waveguide-cladding stack 606 includes four waveguide-cladding layers 610-n (N=4). Each of the waveguide-cladding layers 610-n includes a cladding layer 612-n and a waveguide layer 614-n. In embodiments, CVD is used to generate each of the four cladding layers 612-n and the waveguide layers 614-n. Use of CVD to build the multi-waveguide-cladding stack 606 enables accurate layer spacing and enables precise control over layer thickness; in embodiments, this enables creation of layers to be smaller than 10 nm. According to embodiments, the mask layer 608 is generated. The mask layer 608 may be made of a photoresist (PR), such as a standard positive photoresist SPR220, and may be generated using an ACS 200 cluster tool for coating, baking, and developing the PR, with a GCA AutoStep™ used for exposure. The method 400 continues to step 420.

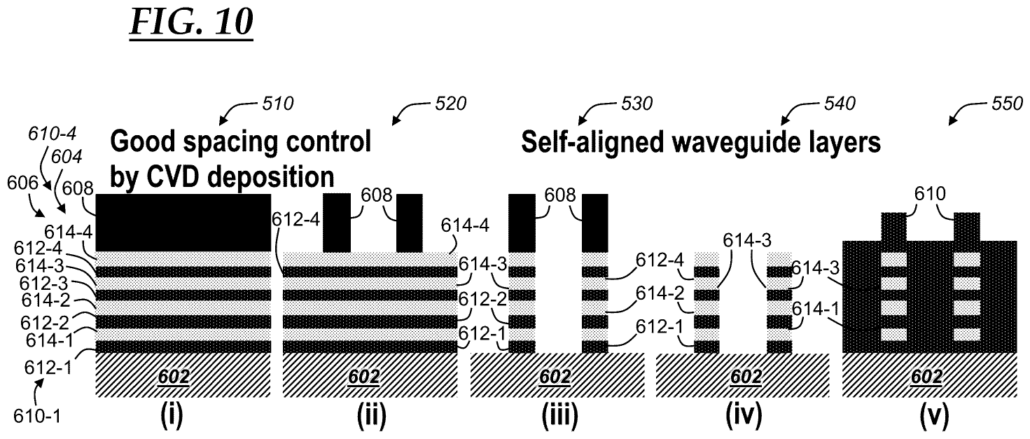

In step 420, simultaneously etching multiple layers of a waveguide-cladding stack to form a plurality of waveguide paths, each of which terminates at a common edge. As shown at 530 (FIG. 10), multiple waveguide-cladding layers are simultaneously etched out of the waveguide-cladding blank 600 so as to form an etched waveguide-cladding structure 620 that is shaped according to the waveguide pattern (used for the etching) when viewed in the plane of the first dimension D1 and the second dimension D2. At least in some embodiments, dry etching is used and, in particular, reactive ion etching (RIE) is used. The simultaneous etching is performed according to an etching profile, which is discussed more below. The method 400 continues to step 430.

In step 430, cladding material is applied to the etched waveguide-cladding structure so as to provide a cladding surrounding the patterned waveguide material. The cladding material is applied using CVD, for example. After applying the cladding material, CMP may be used to planarize the top surface of the OPA by removing excess cladding material. The method 400 then ends.

With reference to FIG. 10, there is shown a 3D edge-firing OPA 600 throughout five different stages during a single lithography fabrication process. In embodiments, the method 400, or parts thereof, is/are used to achieve various stages 510-550 shown in FIG. 10. In particular, FIG. 10 illustrates the 3D OPA 600 at five stages: (i) stage 510: masked multi-waveguide-cladding stack generation; (ii) stage 520: mask layer patterning; (iii) stage 530: simultaneous etching of the multi-waveguide-cladding stack; (iv) stage 540: mask removal; and (v) stage 550: cladding deposition.

At the masked multi-waveguide-cladding stack generation stage 1510, a masked multi-waveguide-cladding stack 604 is generated. This is carried out as discussed above with respect to step 410 where layers are deposited onto a base substrate to form the multi-waveguide-cladding stack 604. According to embodiments when dry etching, such as RIE, is used, the mask layer is consumed during etching and accordingly, when applied to single-mode applications, the number of waveguide layers that are able to be etched simultaneously depends on the thickness of the mask layer, which depends on the thickness of the photoresist (PR). The thickness of the PR layer is limited by the feature size of the device, and the feature size of the device is the waveguide width, which is limited by the single-mode condition, at least according to embodiments. In the exemplary OPA device 600, Si₃N₄ is selected as the waveguide material due to its better performance in passive devices than Si, and SiO₂ is selected as the cladding material. According to the simulation results, it was discovered that 1100 nanometers (nm) is the largest width that still allows the Si₃N₄ waveguide to be in single-mode. Then, based on this, the thickest PR that can constantly offer 1100 nm resolution is determined, such as is described below, for example.

In embodiments, the PR used for the PR layer is a standard positive photoresist SPR220. An ACS 200 cluster tool may be used for the coating, baking, and developing of the PR, and a GCA AutoStep™ may be used for exposure. Also, the spin rate in the coating step may be tuned to achieve different PR thicknesses, and the exposure matrix method is utilized to determine an exposure time and offset. According to the experiment result, it was found that the thickest PR that is able to offer 1100 nm resolution is approximately 4 μm. An end of an input taper and the first (binary split or) Y-splitter of the device at 4 μm PR was imaged and this imaging was focused when a clear boundary of the larger triangles visible; at this focusing, the narrow waveguides are also in focus, which indicates that the small features and large feature are at the same thickness after PR developing. Also, the same part at 5 μm PR was imaged, where the larger triangular parts can be developed well, but the narrow waveguide lines are not in focus; this means that when the large features are sufficiently developed, the small features are already over-developed. This is a result of the too-thick PR. Therefore, it has been determined that the thickest PR for the 1.1 μm feature size is approximately 4 μm. Of course, it will be appreciated that this is only one embodiment and that different feature sizes and other parameters may be selected according to requirements of the OPA to be fabricated.

At the mask layer patterning stage 1520, which may be formed through emitting ultraviolet (UV) light downward through a photomask toward the photoresist (PR) mask layer 608 so that the UV light disintegrates the PR so as to pattern the mask layer 608.

At simultaneous etching stage 530, a self-aligned multi-waveguide-cladding stack 604 is generated as a result of simultaneously etching through multiple layers of the multi-waveguide-cladding stack 604 to generate vertically aligned waveguide paths and terminal portions or emitters. The etchant used for the simultaneous etching may be CF₄, C₄F₈, and/or H₂. In the illustrated embodiment, a soft (or not a hard mask, as in a-Si hard mask) mask etching is performed in the illustrated embodiment of FIG. 10. According to embodiments, a mixture of CF₄, C₄F₈, and H₂ is used as the etchant to achieve different selectivity and directionality. Table 1 below summarizes the etching rate during experimentation using three different etching methods A-C: Method A used only PR as the mask, with etchant composition to achieve the best directionality; Method B used only PR as the mask, with etchant composition to achieve the best selectivity; Method C used a-Si as the hard mask, and this method requires a two-step etching, where the a-Si is firstly etched by PR, then the Si₃N₄/SiO₂ stack is etched by a-Si. In the experiment, an STS Glass Etcher™ at Lurie Nanofabrication Facility in Ann Arbor, Michigan, was used and the gas mixture included a large amount of helium of 174 sccm and a small portion of etchant gas of a maximum of 40 sccm. A mixture of CF₄, C₄F₈, and H₂ is used as the etchant to achieve different selectivity and directionality; HBr is used to etch the a-Si (in a different tool). Table 1 summarizes the etching rate in the 3 different etching methods, the data are tested on blank wafers.

TABLE 1

| | | | Flow | | | | |
|---|---|---|---|---|---|---|---|
| | | | rate | Etching rate (A/s) | | | |
| Methods | | Etchant | (sccm) | Si₃N₄ | SiO₂ | PR | a-Si |
| A | Best | CF₄ | 40 | 55.7 | 53.1 | 41.7 | — |
| | Directionality | | | | | | |
| B | Best | C₄F₈ | 10 | 45.1 | 32.0 | 8.3 | — |
| | Selectivity | H₂ | 30 | | | | |
| C | Using a-Si | HBr | 100 | — | — | 4.6 | 20.0 |
| | Hard Mask | CF₄ | 20 | 20.6 | 55.7 | — | 8.4 |
| | | C₄F₈ | 20 | | | | |

With fluorocarbon-based etch processes, the reaction depends on a combination of surface passivation of the fluorocarbon and ion bombardment breaking the bonds in the etched material so they can combine with the fluorocarbon, creating a volatile byproduct. At least according to embodiments, the etching itself is highly dependent on the respective rates of these two processes, and the higher the carbon content in the gas mixture used, the faster the passivation rate; this will slow down the etching process since more energy is required to break through the passivation layer, and this effect is stronger on the PR than on SiO₂ and Si₃N₄, so it leads to a higher selectivity. On the other hand, this effect also leads to a more tapered etching profile, since ion bombardment tends to be weaker at the edge of features, and some of the ions will be shadowed by the passivation layer and their trajectories will not be perfectly perpendicular to the wafer surface. In addition, adding H₂ could reduce free fluorine content in plasma, creating a similar effect to higher carbon content.

From the data in Table 1, with the knowledge of the maximum thickness of PR to be 4 μm, the number of waveguide layers that are able to be etched in one lithography or through a simultaneous etching step is calculated. Method A discussed above (see Table 1) has the highest fluorine content, which leads to the best directionality; but on the other hand, the selectivity is lower, so the maximum number of layers that can be etched in one lithography is 4 layers. Method B has the highest carbon content (H₂ further reduces the fluorine content), so this method has the best selectivity, and 14 layers of waveguides are possible to be etched at one time. Method C uses a hard mask, which results in an even larger overall selectivity, so etching 50 layers are possible at one lithography or in one simultaneous etching step. These estimations are simply calculated based on the etching rate from the blank wafer.

The results of the etching profile check were obtained from a test done on the substrate with 3-SiN-layer Si₃N₄/SiO₂ stacks. It can be seen that the etching profile from Method A is very vertical, and this is due to the chamber configuration and gas mixture of the STS Glass Etcher. Because of the relatively small portion of the etchant in the gas mixture, the etching process is extremely ‘diluted’, which inhibits excessive polymerization during the etching; the tool also runs at a very low pressure, which also helps with the etching profile.

From the etching profile of Method B (best selectivity with PR), it can be seen that the gratings are tapered (angled relative to the vertical direction, the third dimension D3). The reason for the taper is the relatively fast growth of the passivation layer, as explained above. Since the taper is already apparent in the 3-SiN-layer substrate, it can be deduced that the tapering effect will be significantly stronger in a 14-SiN-layer substrate, and the top layers will not be able to maintain the dimensions, which may not be acceptable for some 3D OPA devices.

The test etching for Method C was done on a substrate with 3 μm SiO₂, 2 μm a-Si, and 0.97 μm PR. The etching profile after the first step of a-Si etching (etching the a-Si hard mask), it can be seen that the etching of a-Si is fairly vertical, and the etching stopped on the surface of SiO₂ cleanly, this is due to the great selectivity between Si and SiO₂. In this step, about 270 nm PR is consumed. There is shown a picture from eight (8) minutes after the second etching (after the simultaneous etching of the stack) and, at this time, the etching on the SiO₂ is vertical, but the a-Si hard mask already started to degrade because of the faceting effect. This effect usually happens in the etching which is dominated by physical sputtering but not a chemical reaction; in such a process, there is a strong sputter yield dependence on the incidence angle of the incoming ions. In the second step of Method C, the etching rate of a-Si is low, which indicates that this etching is dominated by physical sputtering. At the corner of a feature, which is typically slightly (maybe not even visibly) rounded, a specific angle will develop where the sputter yield is highest, resulting in a degradation of the features. This degradation had not merged into SiO₂ layers at the stage of 8 minutes of SiO/SiN etching, so the SiO₂ features still appear vertical; but, the profile taken after sixteen (16) minutes of the second etching, and the degradation had merged into SiO₂. In the OPA sample, Method C eventually results in that only a few layers of Si₃N₄ waveguide maintain after a long etching, so this method may not be acceptable for some 3D OPA devices.

The etching rate in Table 1 was tested on blank wafers. However, in the small openings, the etching rate is usually slower due to the fact that etchant ions are hard to enter in to such openings. When using Method A, it was calculated that four (4) layers of Si₃N₄ waveguides are possible to be etched in one lithography (one simultaneous etching step). To achieve a full etching on the four (4) layers, small openings may be avoided, at least according to embodiments. The etching profile at small openings is visible through imaging of the OPA, with the images having been taken from a testing wafer containing isolated gratings with different openings, and the grating width is 500 nm. The etching depth at the large openings is approximately 1.2 μm, while at small openings are: (a) 290 nm at 1 um openings; (b) 1030 nm at 2.5 μm openings; (c) 1040 nm at 4 μm openings; (d) 1200 nm at 5.5 μm openings. A relatively shallow etching is proceeded in the testing to observe the etching differences in small openings. From such images, it can be observed that the etching depth at large openings is approximately 1.2 μm over the whole wafer, while the etching depth is obviously shallower at small openings; it is etched approximately 290 nm at 1 μm openings, 1030 nm at 2.5 μm openings, 1040 nm at 4 μm openings. Eventually, when the opening size reaches 5.5 μm, the etching depth at the center of the openings becomes roughly as same as the depth at large openings.

A completed 4-layer sample was made using a fabrication process that included using a 4 μm PR as the mask layer, Method A for etching, and 6.9 μm as the smallest openings in the device. An image was captured using dedicated backscattering scanning electron microscopy (SEM) imaging. The Y-splitter tree and the delay line region can be distinguished from the image. In the image, four Si₃N₄ end-fire or edge-fire emitters can be distinguished, the image is taken from an angle, which results in the gradient in darkness of the edge emitters from top to bottom. From the image, part of the Y-splitter tree and the Ω-shape delay line region can be distinguished. The image is taken from an angle so that the end surface is presented, and the tooth-like shape at every pitch is the result of the plasma enhanced chemical vapor deposition (PECVD) cladding on a high aspect-ratio grating.

The optical performance of the fabricated OPA is tested using a commercial tunable laser and the Fourier optics measurement. The results show that the 3D OPA device can emit a beam with vertical convergence of 17.42°, which indicates that the spacing and calibration between layers are fabricated as design.

The above-described simultaneous etching (or “single lithography”) fabrication process addresses layer spacing issues and layer calibration issues that arise in the normal multi-layer process. In this single lithography process, the layer spacing is controlled by CVD deposition, so the accuracy of the spacing thickness is able to be much better than the control in a CMP process; layer calibration is achieved by self-alignment. In addition, an etching method with a very vertical (aligned in the third dimension D3) etching profile is selected. Therefore, it ensures that the pattern at every waveguide layer is the same. The above-described process was implemented at the LNF and, when implementing such a process somewhere else, the detailed process parameters and the etching possibility may be different. The single lithography fabrication process is more suitable than the conventional method for a multi-waveguide-layer PIC, namely when the PIC is to have the same pattern on every waveguide layer and is sensitive to the fabrication errors in layer spacing and calibration, at least according to embodiments.

With reference back to FIG. 6, a single-mode fiber (SMF) is used as the optical fiber 14 and is shown therein as being coupled to the waveguide layers via the waveguide edge coupling region 115. The mode match is supported by multiple waveguide layers to maximize the coupling efficiency. In addition, the thickness of Si₃N₄ waveguide layers and SiO₂ isolation layers are selected to minimize vertical crosstalk, as discussed below. A taper waveguide is applied to convert the mode size into single-mode waveguides, and a Y-splitter tree is then used to split the light into multiple channels (16 channels for every layer in FIG. 6), and the phase in each channel is the same. The Ω-shape delay line region is designed to enable the beam steering capability. To achieve such functionality, a certain delay length is applied between each waveguide, introducing an extra artificial dispersion effect so that the emitting beam can be steered horizontally by wavelength tuning. At the emitting end on the emitter side, a 2D end-fire array is formed on the side of the device; the light is edge-coupled into the free space or atmosphere. The emitting efficiency is relatively high in a broad bandwidth due to the edge coupling. In short, the 2D array shapes the light beam in the following manner: in the horizontal direction, the Ω-shape delay line region controls the phase profile of the array; and in the vertical direction, the phase profile inherits the profile from the input optical fiber 14. In the present embodiment, the design for every waveguide of the waveguide layer is selected to have the same pattern, so there is no phase difference between layers. Si₃N₄ and SiO₂ are selected to be the waveguide and cladding material considering both device performance and fabrication possibility. [S. Tarun, J. Wang, B. K. Kaushik, Z. Cheng, R. Kumar, Z. Wei, X. Li, Review of recent progress on silicon nitride-based photonic integrated circuits. IEEE Access 8, 195436 (2020)], [X. Chao, W. Jin, J. E. Bowers, Silicon nitride passive and active photonic integrated circuits: trends and prospects. Pho. Res. 10, A82 (2022)].

There are two disadvantages when applying the edge coupler to a single-layer OPA in a trivial way: the mode mismatch at the input end, and the non-convergence in the vertical direction at the output end. These disadvantages are addressed in this work by utilizing the multi-waveguide-layer configuration over the whole device. In the following discussion, the design of the input coupler is introduced, with the mode match supported by the multi-waveguide layer configuration, and this is then followed by experimental results, which provides a proof-of-concept to show the broadband high efficiency and the 2D converged beam.

The optical fiber (also referred to as input fiber) used in one implementation is SMF-28-J9 (Thorlabs™), which has a mode field diameter (MFD) of 10.4 μm. The layer thickness of the OPA is optimized to minimize vertical crosstalk. With the selected layer thickness, it can be calculated that eight waveguide layers can cover the full MFD; in implementations, the number of layers may be predetermined and used to set the layer thickness, however, in other embodiments, a layer thickness may be used to set the number of layers to be used. The mode profile for three positions may be analyzed to assess mode matching: at the optical fiber, at the on-chip edge coupler (before taper), and the single mode waveguide after an initial taper; these positions have been labeled in FIG. 6.

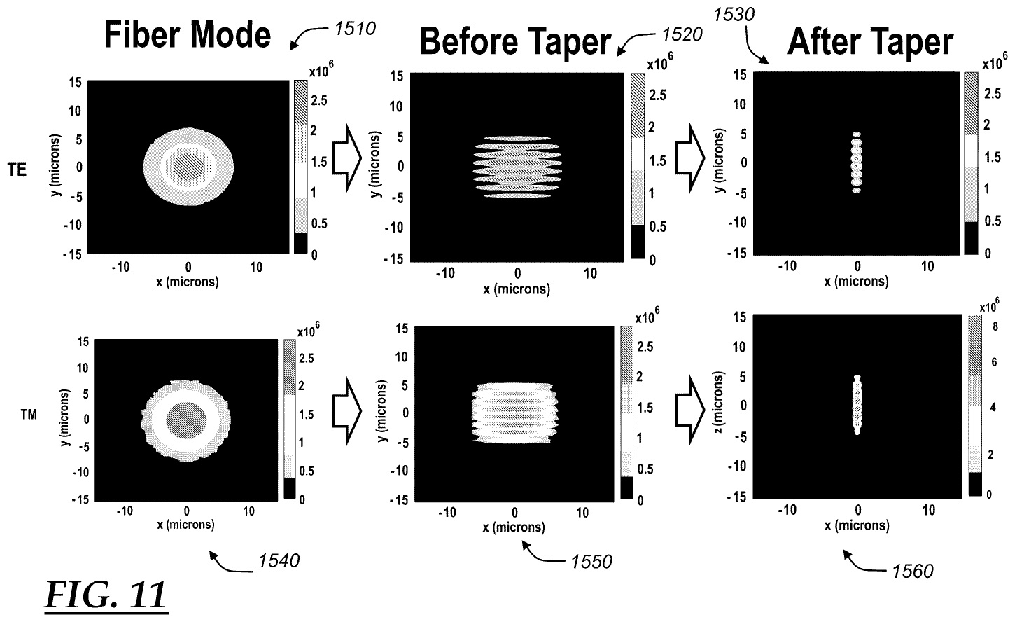

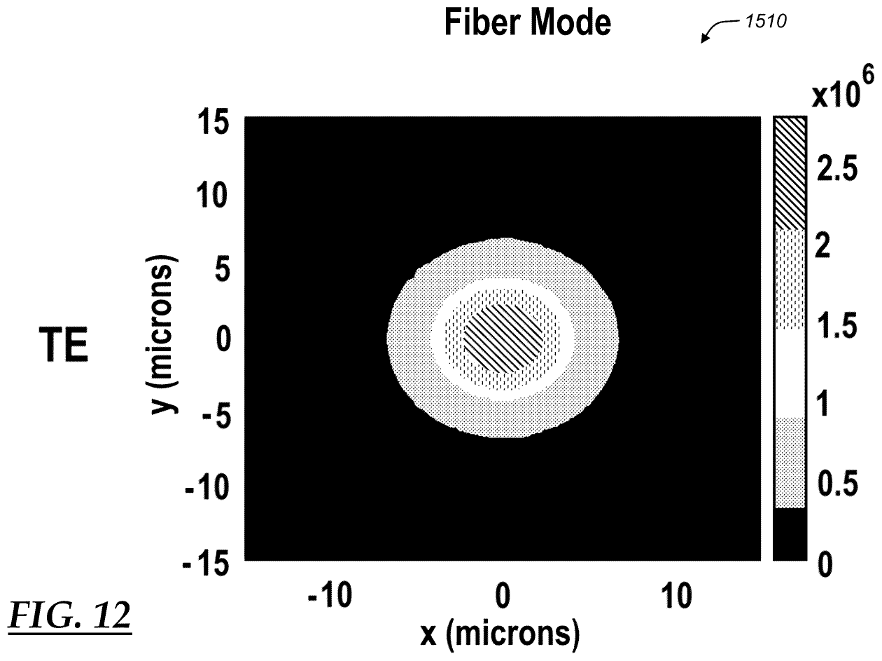

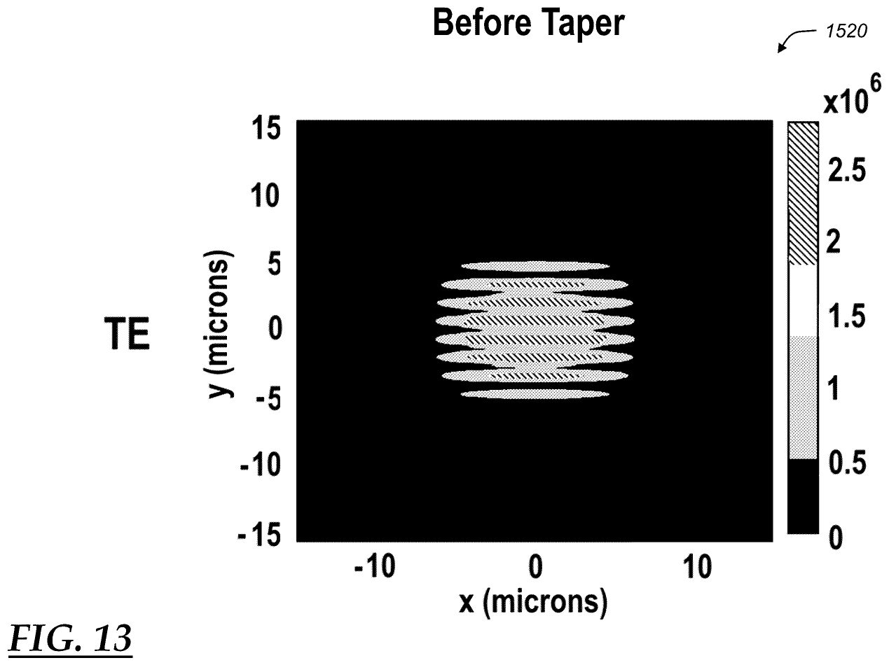

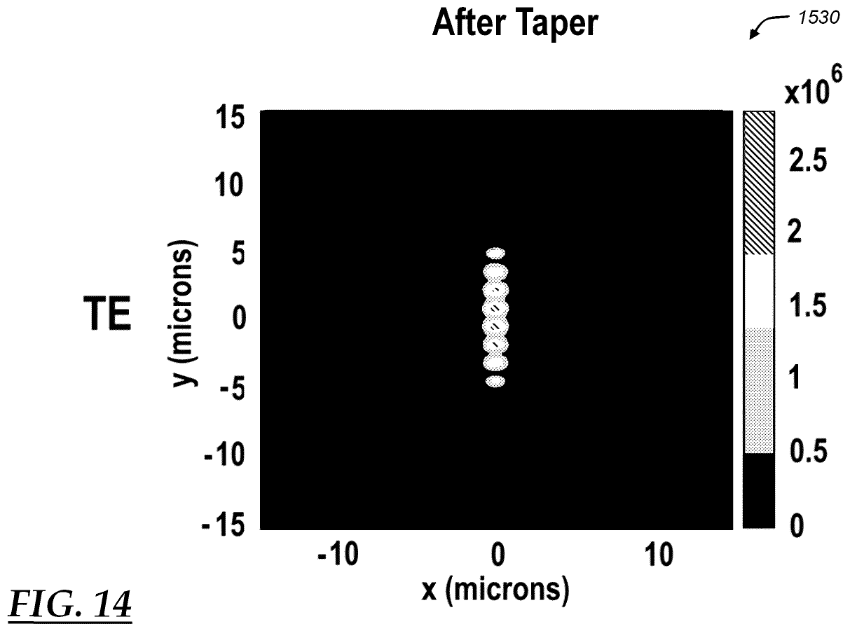

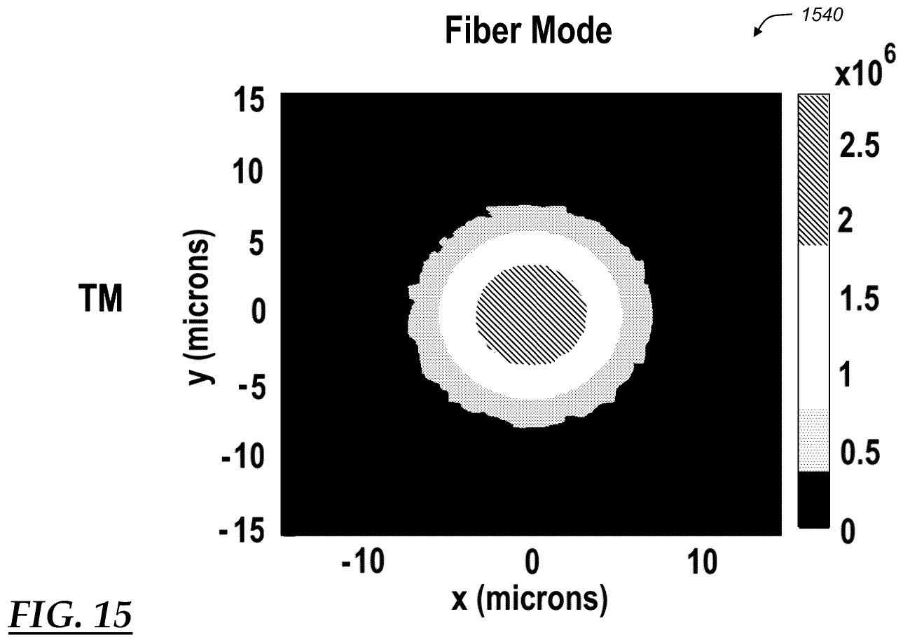

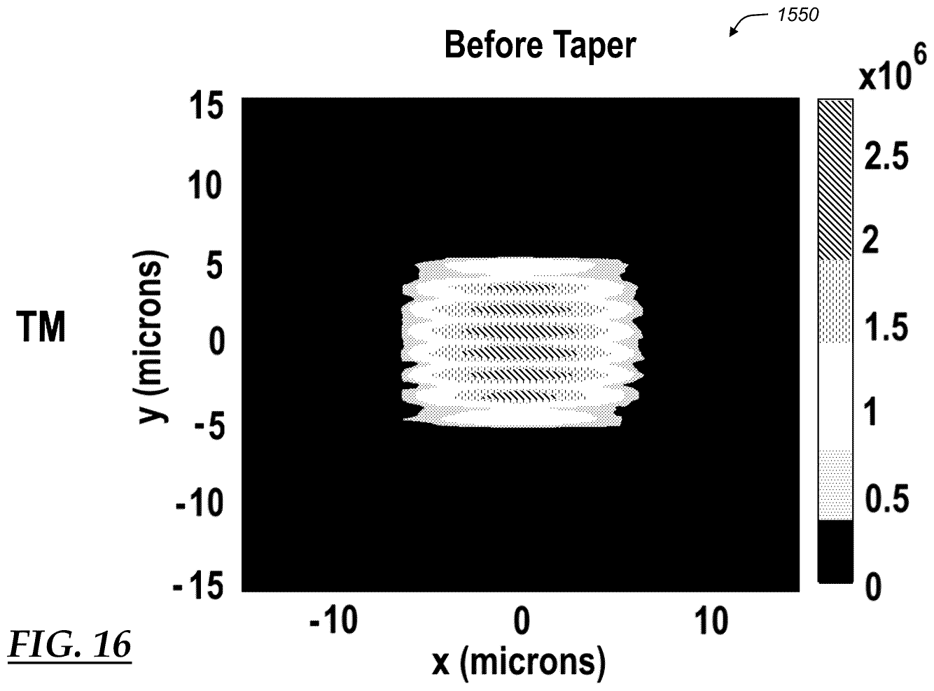

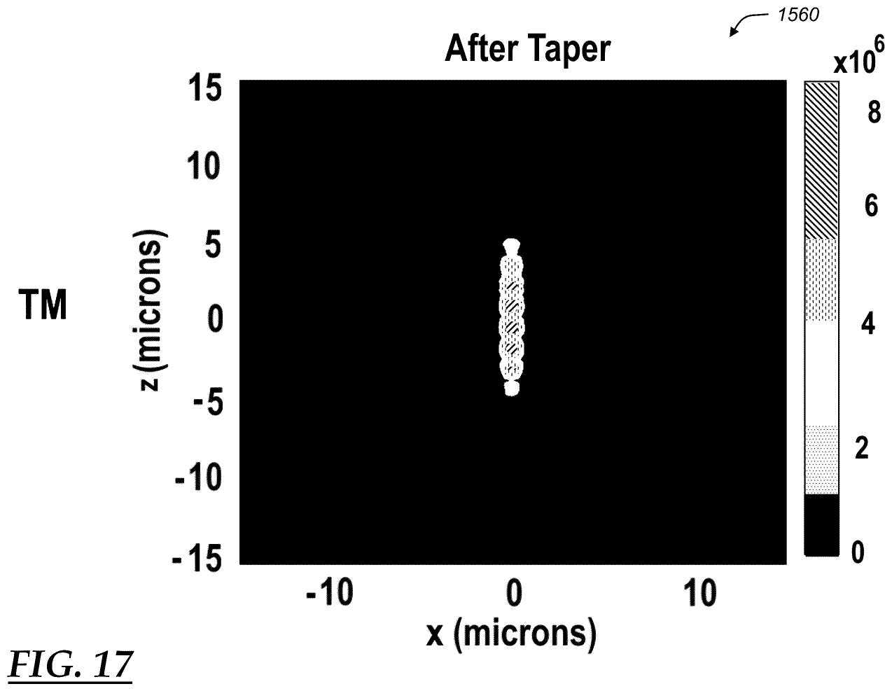

FIGS. 11-17 illustrate mode profiles 1510, 1520, 1530, 1540, 1550, 1560 using different polarizations (TE polarization and TM polarization) at different portions of the OPA device, including at the optical fiber (FIGS. 12 and 15), in the waveguide layer of the OPA before tapering (FIGS. 13 and 16), and in the waveguide layer of the OPA after tapering (FIGS. 14 and 17). The mode profiles 1510, 1520, 1530, 1540, 1550, 1560 as shown in FIGS. 11-17 were generated using a simulation, where the comparison between TE polarization (shown in FIGS. 12-14) and the TM polarization (shown in FIGS. 15-17) shows that the TM polarization has more field distribution into the cladding layers, such as the cladding SiO₂ layers; this is better for the fiber to waveguide coupling as it can offer a better mode match. However, this mode profile is not desired in two aspects: firstly, it will increase the optical loss for all the components, including waveguide, bending, and splitters; and secondly, it does not help minimize the vertical crosstalk. On the other hand, the energy intensity of TE mode is more confined in the waveguide material, which is desired in this device. Therefore, TE polarization is selected in the embodiment discussed below. However, it will be appreciated that TM polarization may be selected according to embodiments, such as where better mode match is prioritized over minimizing optical loss and vertical crosstalk.

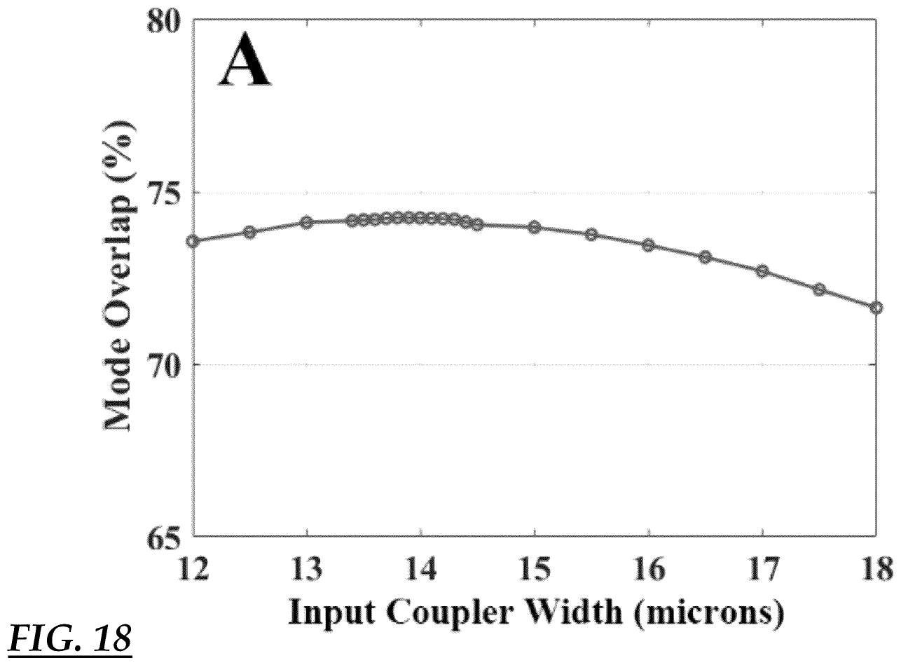

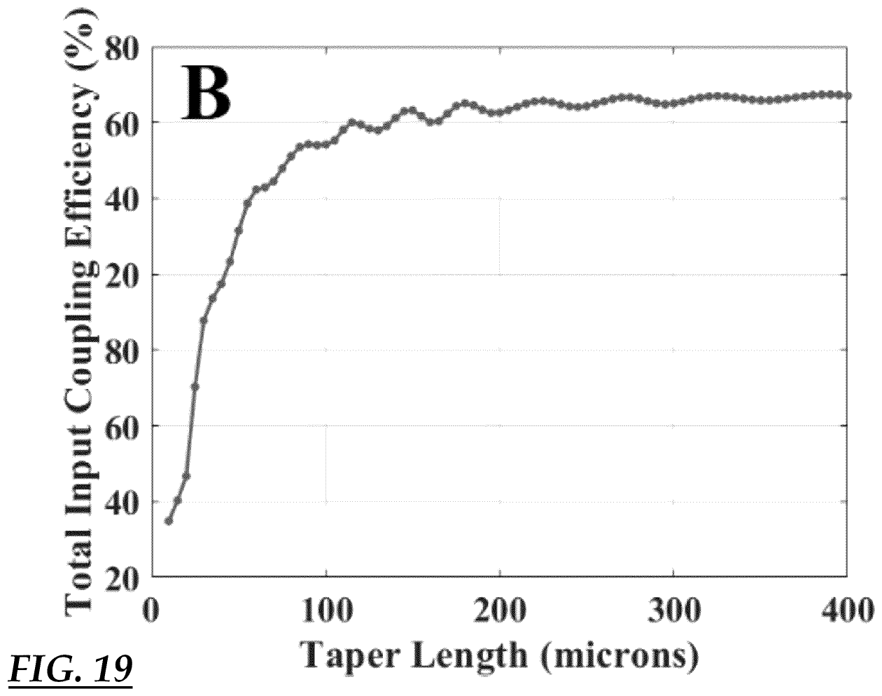

The width of the on-chip coupler (labeled as before taper as shown in mode profile 1520 and 1550) and the taper length is then optimized at the wavelength of 1550 nm with TE polarization. In the present embodiment, every layer was designed to be in the same pattern so that the phase profile across the OPA inherits the profile from the optical fiber. Thus, the on-chip edge coupler width for every layer is the same in this design. FIG. 18 shows the sweeping results for the coupler width; the first coarse sweeping is done with a step of 0.5 μm, then a fine sweeping is followed with a step of 0.1 μm at 13.5 μm to 14.5 μm, the results show that a taper start width of 13.9 μm, which offers the best mode match, with the coupling efficiency from fiber to coupler is 74.23%. Two factors contribute to the coupling loss: firstly, Fresnel reflection occurs on the interface between fiber and the device; and secondly, the layer thickness is selected to minimize the vertical crosstalk; this selection also makes that the mode profile is nearly zero at the center of every insulation SiO₂ layer, which results in partial mode mismatch. FIG. 19 shows the sweeping results of the taper length; the vertical axis in this figure is the total coupling efficiency of the edge coupler. The result curve gradually converges to 73.67% when the taper length approaches 400 μm; this corresponds to a 99.25% taper efficiency (73.67%/74.23%=99.25%). In this embodiment, the taper length is selected to be 150 μm; the corresponding coupling efficiency was determined to be 71.24%. Although it will be appreciated that the particular taper length (taken from the taper start 113-S to the taper end 113-E in the second direction D2) may vary, the taper length is within the range of 100 μm to 200 μm.

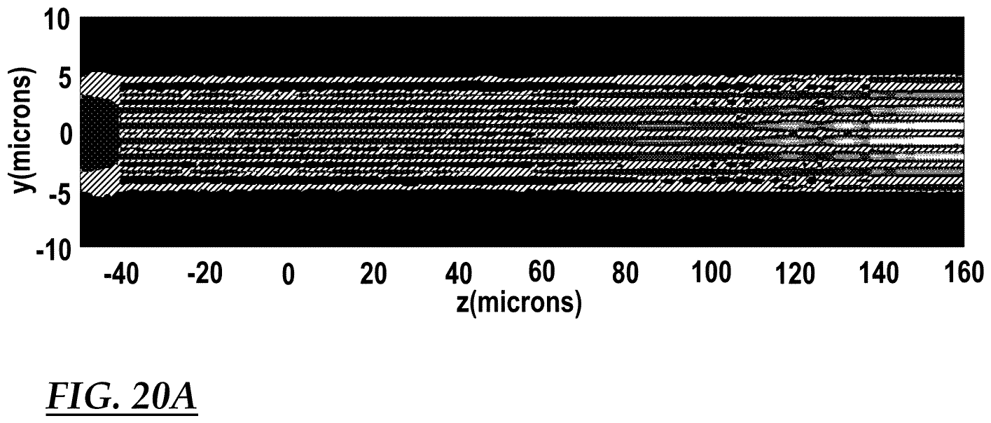

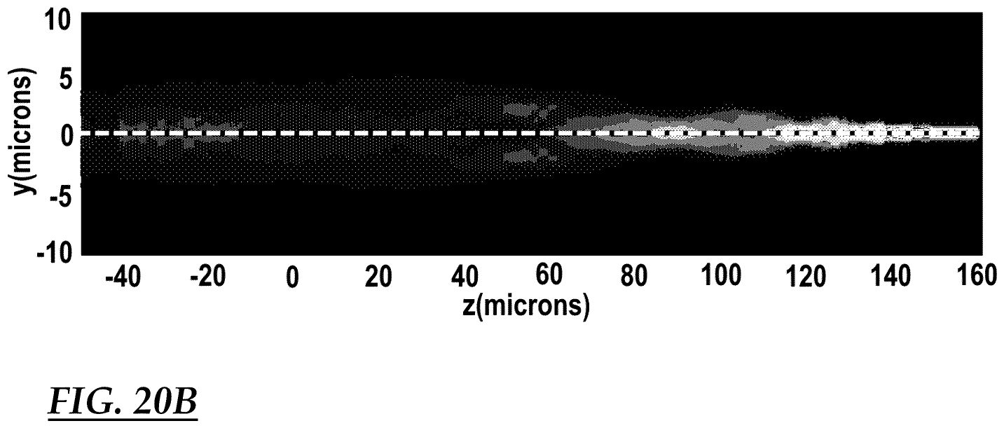

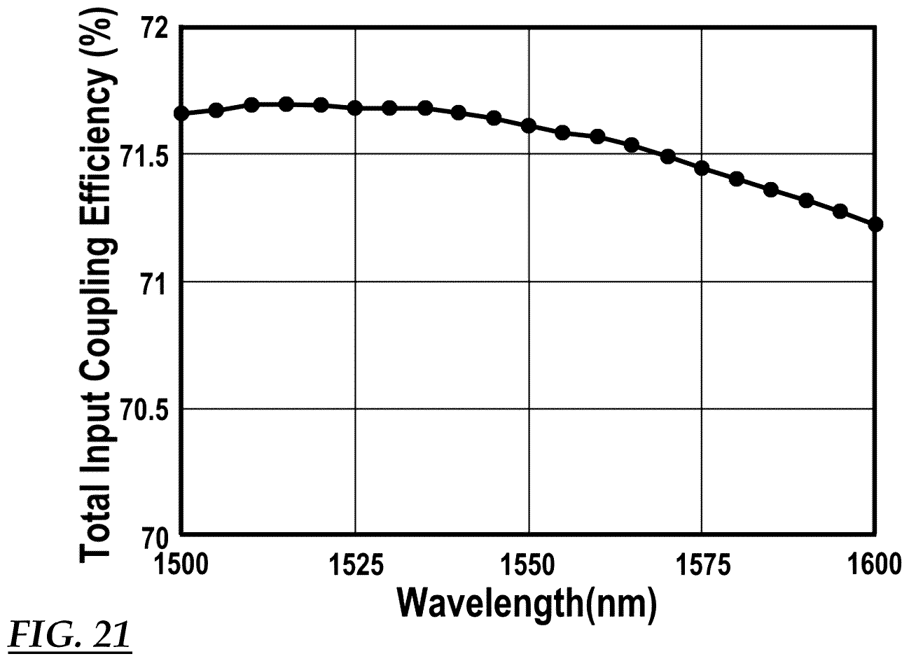

The mode propagation in the coupling region is plotted in FIGS. 20A-B show the side-view cross-section. More specifically, FIG. 20A shows propagation across the entire input coupler from cross-section view (dashed line in 20B) at 1550 nm, where the light propagates individually along every layer. FIG. 20B shows mode propagation in the whole input coupler from the top view, specifically the top-view cross-section illustrating the mode size conversion between the fiber and the single mode waveguide. The layer thickness selection enables individual light propagation in all eight layers, as shown in FIG. 20A. As stated above, the coupling efficiency from an edge coupler is relatively stable in a broad bandwidth; the coupler is optimized at the wavelength of 1550 nm, and the coupling efficiency is tested over the wavelength region of 1500 nm to 1600 nm. FIG. 21 shows the results, the highest efficiency is 71.70% at 1515 nm, and the efficiency variation in the whole range is only 0.58%. The simulated coupling efficiency of the entire input coupler at 1500 nm to 1600 nm wavelength range. The maximum efficiency appears at 1515 nm to be 71.70%. Note this is the result without anti-reflection coating.

A proof-of-concept experiment was carried out with the samples being fabricated in the Lurie Nanofabrication Facility (LNF) in Ann Arbor, Michigan, USA. Samples with 1 to 4 waveguide layers have been fabricated to prove the concept. The experimental results are useful in comparing the single-layer and multi-layer configurations. Below, the experimental results are presented, which clearly show that the 4-layer sample is better than the 1-layer sample in the coupling efficiency and beam convergence.

The input coupling efficiency is measured with the testing samples in the wavelength range from 1530 nm to 1600 nm (the source wavelength range is the C+L band, which is generated from Thorlabs™ TLX1 and TLX2).

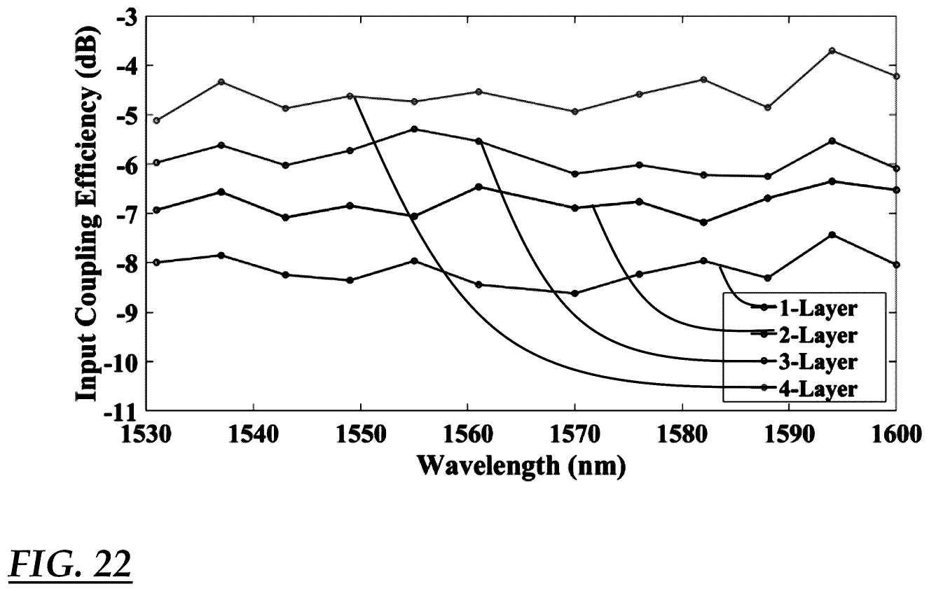

FIG. 22 shows testing results of the input coupling efficiency, where testing structure with a straight waveguide and symmetric coupler configuration is utilized to test the efficiency. The testing is done at the C+L wavelength band (1530 nm to 1600 nm) with laser sources TLX1 and TLX2 from Thorlabs™.

Compared to the typical Gaussian-curve spectrum from a grating coupler, the tested curves for the 1-layer to 4-layer devices are relatively flat; this is due to the edge coupler, which couples the light by direct mode match, but not the harmonic wave match (which is the case of the grating coupler). As a result, the input coupling efficiency for the 1-layer device is average −8.12 dB with a variance of 0.09 dB2, and the efficiency is improved to an average of −4.57 dB with a variance of 0.13 dB2 for the 4-layer device. Note these tested values includes the taper efficiency. These results show that the multi-waveguide-layer configuration can enhance the fiber-to-chip coupling efficiency. The fluctuation of the curves being mainly due to the operation variations in the experiment. Compared to the simulated results (average of −7.58 dB for 1-layer structure and −2.64 dB for 4-layer structure), the tested efficiency of the 1-layer sample is 0.54 dB lower than the simulated value; this is because of the extra-waveguide loss due to the waveguide layer roughness from the fabrication error. This issue is more vital in the 4-layer device, as the roughness of the layers accumulates in the sample, which results in a more considerable propagation loss in the 4-layer device. Therefore, the tested input coupling efficiency of the 4-layer sample is 1.93 dB lower than the simulated value. It can be expected that this issue will be minimized with the state-of-the-art deposition method in an advanced foundry.

The fiber-to-chip and emitting coupling are the two significant optical losses in a standard OPA device. As stated above, edge couplers are utilized over the whole device to achieve high efficiency at both ends, and the multi-waveguide-layer configuration may enhance the mode match between the fiber and the coupler at the input end. Each waveguide layer matches a part of the fiber mode, so the total mode match is good. The light propagates individually at each layer, then emits through the end-fire emitter, interferes with the light from other layers in the free space, and eventually forms one or several (depending on the aliasing effect) beams. At the input end, the edge coupler relies on the multi-waveguide-layer configuration to achieve a good mode match. At the output end, the light is coupled from OPA to the free space, so there is no issue of mode mismatch. Compared to the grating couplers, which generate a considerable substrate leakage [D. Wu, W. Guo, Y. Yi, Compound Period Grating Coupler for Double Beam Generation and Steering. Appl. Opt. 58, 361 (2019)], using edge couplers will increase the emitting efficiency to approximately 70% (−1.55 dB) [D. Wu, Y. Yi, Y. Zhang, High efficiency end-fire 3-D optical phased array based on multi-layers Si₃N₄/SiO₂ platform. Appl. Opt. 59, 2489 (2020), referred to herein as “Wu et al.”], regardless of how many waveguide layers are in the sample. Note this efficiency is obtained when the device has no antireflection coating, so the Fresnel reflection produces that 30% loss. Fresnel reflection can be suppressed by anti-reflection coating; in principle, a correct anti-reflection coating can increase the theoretical emitting efficiency to nearly 100%

The issue at the emitting end is the beam convergence. As proved in the previous studies, an end-fire OPA with a single-waveguide-layer configuration essentially means a fan-beam with only 1D convergence. In such a case, even though the OPA can have high optical efficiency, the beam's energy will be distributed in a vertical line with about 35° FWHM (according to the simulation), which means that the optical efficiency at one particular angle is still low. This issue is also addressed in this work by the multi-waveguide-layer configuration. The farfield pattern was tested at 1550 nm wavelength with samples without the Ω-shape delay line region being used for this testing, as they consistently emit the main lobe to the normal direction. Testing was performed for the farfield pattern for the 1-layer sample, and the farfield pattern for the 4-layer sample. It can be observed that the beams in the 4-layer sample have apparent better vertical convergence than in the first-layer sample. This is clear evidence to show the multi-waveguide-layer configuration address the vertical convergence issue. In the 1-layer sample, the emitting aperture is approximately 600 nm. On the other hand, all waveguide layers have the same pattern in the 4-layer sample, which ensures no extra phase difference between layers. Consequently, the OPA emits the same vertical phase profile as the fiber mode, with only slight variation caused by the fabrication errors. Meanwhile, the emitting aperture has been increased to approximately 4.5 μm, which is 9 times greater than the 1-layer sample.

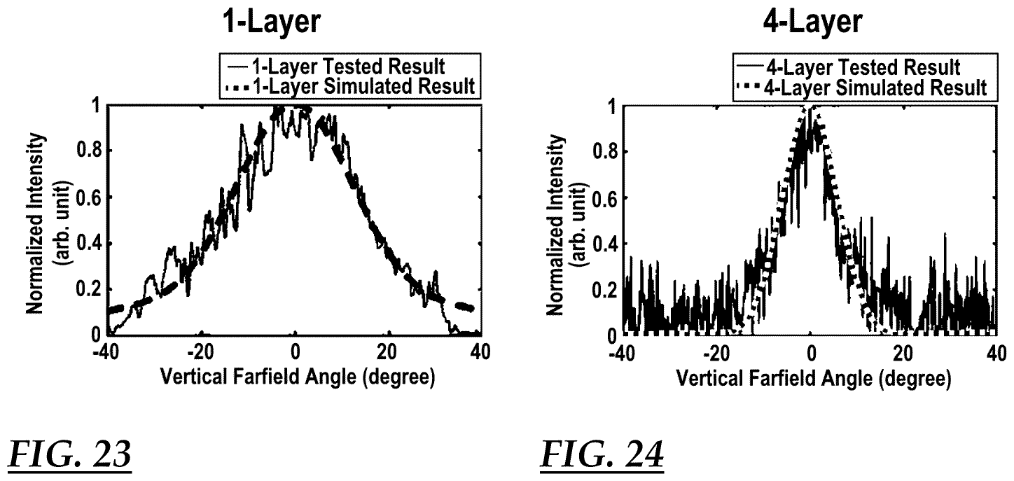

FIGS. 23-24 show the vertical cross-section of the samples, with the smooth-shaped curves being the simulated results, and the other curves being the tested results. A good fit can be observed between the simulated and experimental results, which validate the effectiveness of the design. The tested FWHM for the 1-layer sample is 37.64° (simulated result is 32.12°), and for the 4-layer sample is 17.42° (simulated result is) 14.26°. Based on the simulation result, a complete 8-layer device should be able to offer a vertical FWHM of approximately 5° [Wu et al.]. It is also worth mentioning that the aliasing effect can be observed in FIGS. 23-24; those grating lobes appear at approximately +11.20°, which agrees with the horizontal pitch of 8 μm that to be used in this work. In addition, it is possible to expect that an aperiodic design can be applied to suppress the grating lobes.

The beam shaping and steering in the horizontal direction are achieved by the Ω-shape delay line region. This design introduces an extra artificial dispersion effect into the device, which enables a highly sensitive beam steering capability. It has been proven in a previous study by the same individuals as the present work [Wu et al.] that the beam steering capability is linearly dependent on the length of the delay line, which the following equation can summarize. Δδ=Δλ*DL*b where Δδ is the beam steering angle, Δλ is the wavelength change, DL is the length of the delay line, and b is the essential steering sensitivity, which depends on the waveguide dimension.

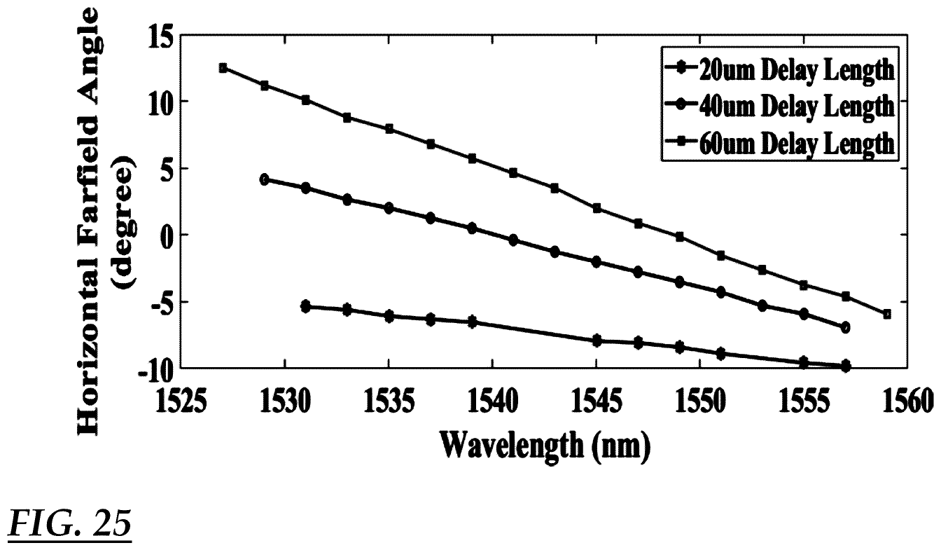

Samples with the delay length of 20 μm, 40 μm, and 60 μm have been tested to validate the beam steering mechanism. FIG. 25 shows a plot of the tested beam steering capability from the 4-layer devices. The angle shown in the figure is the farfield angle of the main lobe. The red, blue, and green lines are for the samples with the delay length of 20 μm, 40 μm, and 60 μm, respectively. The data shows that the 20 μm sample can steer the beam from −5.37° at 1531 nm to −9.80° at 1557 nm, corresponds to −0.170°/nm; the 40 μm sample steers the beam from 4.15° at 1529 nm to −6.92° at 1557 nm, corresponds to −0.395°/nm; the 60 μm sample steers the beam from 12.52° at 1527 nm to −5.93° at 1559 nm, corresponds to −0.577°/nm. It can be concluded that the beam can be steered linearly by wavelength tuning, and the beam steering capability is proportional to the delay length, which agrees with the equation Δδ=Δλ*DL*b. Based on this mechanism, the beam steering capability can be manipulated to any design value from 0° to 180° per nanometer wavelength. In the case of using a laser source with a high tuning step, a lower steering capability can be selected to increase the scanning resolution. In the case of a laser source with a narrower wavelength range, a higher steering capability can be set to achieve a large field of view (FOV).

Below, there is discussed a true 3D OPA device with a broadband high efficiency. This example presents the possibility of the multi-waveguide-layer configuration in a PIC. The existence of multiple waveguide layers perfectly addresses the two disadvantages of using the edge couplers in a traditional SOI-based OPA device. Thanks to the multiple waveguide layers, the mode match between the fiber and the on-chip waveguide is enhanced, and the emitting beams also converge in the vertical direction, demonstrating the advantages of the multi-waveguide-layer configuration with the proof-of-concept experimental results. In addition, the beam steering capability, which is enabled in the present embodiment by the Ω-shape delay line region, is validated experimentally. In summary, the proposed 3D OPA device can offer high fiber-to-chip-to-beam efficiency, with the beam to be 2D converged, and with the beam steering capability to be highly sensitive (manipulatable from 0° to 180° per nm wavelength) and simply operatable (only one degree of freedom in operation). This design opens a new possibility for OPA devices.

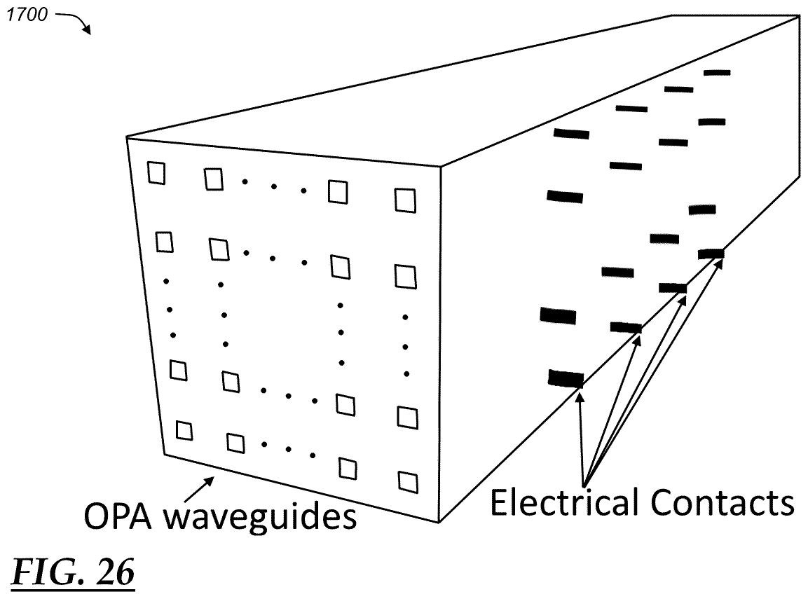

It will be appreciated that, even though the above-discussed embodiment discussed the OPA as having an Ω-shape delay line for beamsteering and uses a single mode configuration, that the on-chip edge coupler and related discussion applies as well to OPAs having other mechanisms for beamsteering and/or using a multi-mode configuration, such as that of the OPA device of FIG. 26 discussed below.

FIG. 26 illustrates a multi-layer OPA 1700 implemented with electrical contacts. In this device, individual phase shifters will be applied to every single waveguide; in such a case, the emitting beam will be 2D steerable. In addition, since the phase in every waveguide can be controlled, the input fiber is no longer required to be single mode; multimode fibers have a much larger core diameter (for example, Thorlabs™ GIF625 has a core diameter of 62.5 μm), so they can easily power approximately 50 layers of the waveguide (in the case of a 1.3 μm distance between layers).

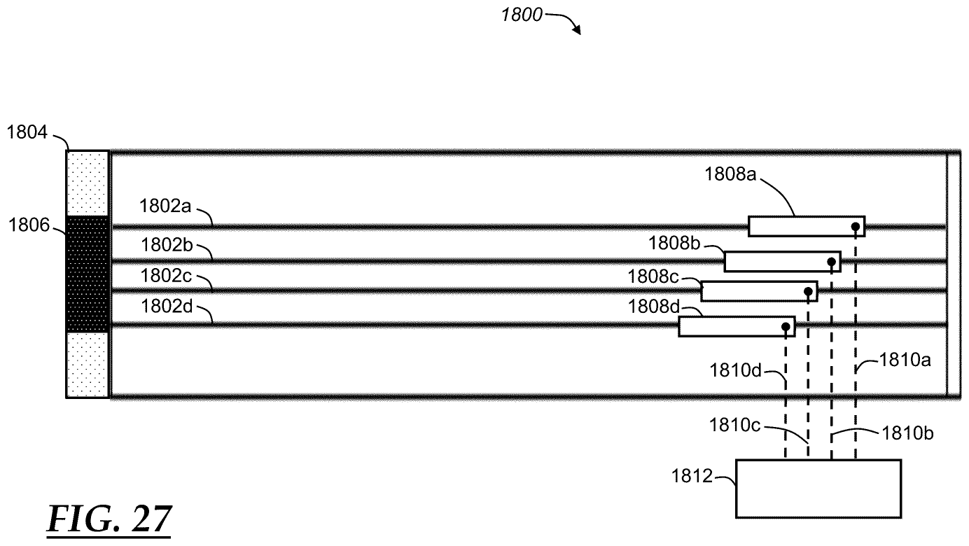

FIG. 27 represents a plan view of a waveguide layer 1800 that may be used for a multi-layer OPA, such as the OPA 1700 of FIG. 26. The waveguide layer 1800 includes four waveguide paths 1802a-d, each of which is independent (i.e., there is no shared path between the collector side and the emitter side) and is coupled to an optical fiber 1804 having a fiber core 1806. The optical fiber 1804 is a multi-mode optical fiber that may have a diameter in the range of 20 μm to 100 μm. The waveguide layer 1800 is shown as having a phase shifter 1808a-d for each of the waveguide paths 1802a-d. Each phase shifter 1808a-d is connected to an electrical contact 1810a-d that is used as input by the phase shifter 1808a-d, which may be provided by a control system 1812.

According to one embodiment, the fabrication strategy of such a device can also be CMOS-compatible, despite being far beyond current fabrication capability. In the expectations, if one day such a multi-layer PIC can be readily available to researchers, a brand-new possibility will be added to the current PIC industry. The recent progress in the electronic IC industry has presented the trend of converting from 2D to 3D; this development also improves the possibility of true 3D PICs.

The samples are fabricated in the Lurie Nanofabrication Facility (LNF) in Ann Arbor, Michigan, USA. Etching multiple waveguide layers in one lithography can ensure vertical alignment between layers; it is applied in the present process. In this work, samples with 1, 2, 3, and 4 layers of Si₃N₄ waveguide are fabricated for comparison. All four samples are fabricated with the same process introduced as follows. Firstly, all the Si₃N₄ waveguide and SiO₂ isolation layers are deposited on a blank silicon wafer. Then, the Si₃N₄ waveguide layers are patterned to the design shape together with the SiO₂ isolation layer. Next, a thick SiO₂ cladding layer is also deposited with PECVD. Finally, the wafer is diced into single dies, and the input and emitting sides of all dies are polished together to ensure uniformity on the surface between different samples.

According to the present embodiment, which was fabricated under constraints of the facility at which it was fabricated (LNF), it is worth noting that several device performances have been sacrificed to etch more layers within one simultaneous lithography step (simultaneously etching multiple waveguide-cladding layers to form a plurality of waveguide paths), ensuring the vertical alignment between layers. Firstly, 8 μm is selected as the horizontal pitch to guarantee the etching depth, as it generates a noticeable aliasing effect in the farfield, which creates several grating lobes and limits the beam steering range of the main lobe. In addition, no samples over 4-layers can be fabricated with the current process. A cladding layer that thoroughly covers the whole structure may be used to achieve an OPA with more than 4 layers, such as 8 waveguide layers.

A 2-lens Fourier optics system is used for the measurement. The light source is tunable laser TLX1 and TLX2 from Thorlabs™, a single mode fiber (SMF-28) with a fiber polarization controller is used for light coupling, and this optical fiber is edged coupled to the device sample. At the emitting end, an objective lens is used to monitor the nearfield of the sample. Once the nearfield pattern confirms a correct light coupling, a second lens is added to image the back focal plane (Fourier plane) to the camera, and thus the farfield pattern of the device is captured.

The coupling efficiency is measured using the testing samples. The waveguide loss is firstly measured using the cut-back method, then the sample with only two couplers and the straight connection waveguide is measured to calculate the coupling efficiency of the input coupling efficiency.

Modeling. In this work, commercial simulation software OmniSim™ (FDTD) and Lumerical™ (FDE & EME) are used for modeling. The Lumerical™ EME engine completes the design of the input coupler, and the OmniSim™ FDTD engine simulates the emitting end.

It is to be understood that the foregoing description is of one or more embodiments of the invention. The invention is not limited to the particular embodiment(s) disclosed herein, but rather is defined solely by the claims below. Furthermore, the statements contained in the foregoing description relate to the disclosed embodiment(s) and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art.

As used in this specification and claims, the terms “e.g.,” “for example,” “for instance,” “such as,” and “like,” and the verbs “comprising,” “having,” “including,” and their other verb forms, when used in conjunction with a listing of one or more components or other items, are each to be construed as open-ended, meaning that the listing is not to be considered as excluding other, additional components or items. Other terms are to be construed using their broadest reasonable meaning unless they are used in a context that requires a different interpretation. In addition, the term “and/or” is to be construed as an inclusive OR. Therefore, for example, the phrase “A, B, and/or C” is to be interpreted as covering all of the following: “A”; “B”; “C”; “A and B”; “A and C”; “B and C”; and “A, B, and C.”

1. An optical phased array device having a plurality of self-aligned waveguides having an on-chip edge coupler at which a single mode optical fiber is coupled to each of the plurality of self-aligned waveguides.

2. The optical phased array device of claim 1, wherein the plurality of self-aligned waveguides is four or more self-aligned waveguides.

3. The optical phased array device of claim 1, wherein the plurality of self-aligned waveguides is eight or more self-aligned waveguides.

4. The optical phased array device of claim 3, wherein the on-chip edge coupler includes a fiber coupling interface that is used to couple to an optical fiber to the plurality of self-aligned waveguides.

5. The optical phased array device of claim 3, wherein a plurality of optical fibers including the optical fiber is coupled to each of the plurality of self-aligned waveguides via the fiber coupling interface.

6. The optical phased array device of claim 5, wherein the plurality of optical fibers are configured as a bunched fiber array in which the plurality of optical fibers and the plurality of self-aligned waveguides are stacked along the same direction.

7. The optical phased array device of claim 3, wherein the optical fiber is coupled to each of the plurality of self-aligned waveguides via the fiber coupling interface.

8. The optical phased array device of claim 7, wherein the optical fiber is a multi-mode optical fiber.

9. The optical phased array device of claim 1, wherein the fiber coupling interface is configured to couple a common edge portion for each of the plurality of waveguide layers to a single mode optical fiber, and wherein the common edge portion for each of the plurality of waveguide layers are each a part of the common edge.

10. An optical phased array device having a fiber coupling interface and a plurality of waveguide layers sharing a common edge at the fiber coupling interface, wherein the fiber coupling interface is configured to couple a single mode optical fiber to each of the plurality of waveguide layers at the common edge.

11. The optical phased array device of claim 10, wherein the fiber coupling interface is configured to couple a common edge portion for each of the plurality of waveguide layers to a single mode optical fiber, and wherein the common edge portion for each of the plurality of waveguide layers are each a part of the common edge.

12. The optical phased array device of claim 10, wherein the plurality of waveguide layers includes a plurality of self-aligned waveguides, and wherein the plurality of waveguide self-aligned waveguides includes four or more self-aligned waveguides.

13. The optical phased array device of claim 10, wherein the plurality of self-aligned waveguides is six or more self-aligned waveguides.

14. The optical phased array device of claim 10, wherein the plurality of self-aligned waveguides is eight or more self-aligned waveguides.

15. The optical phased array device of claim 10, wherein a total number of waveguide layers of the optical phased array is between six and eight, inclusive.

16. A method of fabricating an optical phased array device, comprising: fabricating an optical phased array according to a layer thickness for one or more waveguide layers, wherein the layer thickness is determined based on mode matching data derived from a mode profile at an input coupling interface.

17. The method of claim 16, wherein a process of determining fabrication properties for the optical phased array to be fabricated is performed, and wherein the process includes: determining the layer thickness for the one or more waveguide layers based on the mode matching data derived from the mode profile at the input coupling interface.

18. The method of claim 17, wherein the layer thickness is determined based on a number of waveguide layers that are to be fabricated for the optical phased array, and wherein the number of waveguide layers is greater than one.
